(19) United States
(12) Patent Application Publication
(10) Pub. No.: US 2007/0178963 A1
(43) Pub. Date: Aug. 2, 2007

(54) Gaming machine

(75) Inventor: Kazunobu Sato, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP

(21) Appl. No.: 11/656,554

(22) Filed: Jan. 23, 2007

(30) Foreign Application Priority Data
Jan. 24, 2006 (JP) P2006-015025

(51) Int. Cl. A63F 13/00

(52) U.S. Cl. 463/20

(57) ABSTRACT

A slot machine includes a CPU and a lower liquid crystal display. The CPU displays a plurality of lower treasure boxes on the lower liquid crystal display. The CPU selects one lower treasure box from among the plurality of lower treasure boxes displayed on the lower liquid crystal display in response to an operation by a player. The CPU decreases the number of non-selected lower treasure boxes displayed on the lower liquid crystal display by using code numbers which are assigned to the plurality of lower treasure boxes and prevents the player from selecting one or more decreased lower treasure boxes, or increases the number of lower treasure boxes to be displayed on the lower liquid crstal display and allows the player to select one or more increased lower treasure boxes, when a contet of the selected one lower treasure box is identical to a certain content.

### CROSS REFERENCE TO RELATED APPLICATION

This application claims benefit of priority under 35 U.S.C. § 119 to Japanese Patent Application No. 2006-15025, filed on Jan. 24, 2006, the entire contents of which are incorporated by reference herein.

### BACKGROUND OF THE INVENTION

1. Field of the Invention

The present invention relates to a gaming machine configured to give to a player an award corresponding to an option selected by the player.

2. Description of the Related Art

In a conventional gaming machine such as a slot machine, when a player selects one option among a plurality of options displayed on the gaming machine, the player can get a chance to play a bonus game in which the gaming machine gives to the player an award corresponding to the selected one option. However, it is hard to increase player's expectancy for the award to be given to the player because the award only relates to the selected one option.

In order to solve the above problem, a new slot machine is disclosed in U.S. Pat. No. 6,817,944. In the slot machine, when a player selects one option among a plurality of options in a select game, the player can get a chance to play a bonus game in which the slot machine automatically selects another option neighbor upon the selected one option and gives to the player an award corresponding to the selected another option.

However, another option is limited to an option neighbor upon the selected one option. This monotonizes the bonus game as the player plays the bonus game a number of times because an award within ranges expected by the player will be given to the player.

### SUMMARY OF THE INVENTION

It is an object of the present invention to provide a gaming machine configured to give to a player an award corresponding to an option selected by the player with bringing a fresh sense to the player.

In order to achieve the object, the present invention provides a gaming machine comprising: a display that displays a plurality of options including at least one predetermined option; an input device that accepts input selecting at least one of the plurality of options by a player; and a processor in communication with the display and the input device, the processor operable to: display the plurality of options on the display; select an option based on the input from the input device; determine wehther or not an option selected through the input device is the predetermined option; and change the number of non-selected options displayed on the display if the selected option is the predetermined option.

In order to achieve the object, the present invention provides a gaming machine comprising: a display that displays a plurality of options including at least one predetermined option; an input device that accepts input selecting at least one of the plurality of options by a player; and a processor in communication with the display and the input device, the processor operable to: display the plurality of options on the display; select an option based on the input from the input device; determine wehther or not an option selected through the input device is the predetermined option; change the number of non-selected options displayed on the display if the selected option is the predetermined option; and display at least one additional option being associated with an award equal to or larger than a first award which is associated with any one the plurality of options so that the number of non-selected options is increased.

In order to achieve the object, the present invention provides a gaming machine comprising: a display that displays a plurality of options including at least one predetermined option; an input device that accepts input selecting at least one of the plurality of options by a player; and a processor in communication with the display and the input device, the processor operable to: display the plurality of options on the display; select an option based on the input from the input device; determine wehther or not an option selected through the input device is the predetermined option; change the number of non-selected options displayed on the display if the selected option is the predetermined option; and non-display at least one option being associated with an award equal to or smaller than a second award among the plurality of options so that the number of non-selected options is decreased.

### BRIEF DESCRIPTION OF THE DRAWINGS

FIG. 1 is an explanatory diagram showing display contents in which five lower treasure boxes are added in a treasure bonus game according to an exemplary embodiment of the present invention.

FIG. 2 is a perspective view of the slot machine according to the exemplary embodiment of the present invention.

FIG. 3 is an explanatory diagram of nine valiable display portions of the slot machine according to the exemplary embodiment of the present invention.

FIG. 4 is an explanatory diagram of eight paylines of the slot machine according to the exemplary embodiment of the present invention.

FIG. 5 is a block diagram of a control system of the slot machine according to the exemplary embodiment of the present invention.

FIG. 6 is a block diagram of a liquid crystal driving circuit of the slot machine according to the exemplary embodiment of the present invention.

FIG. 7 is an explanatory diagram showing a symbol row to be variably displayed on each valiable display portion according to the exemplary embodiment of the present invention.

FIG. 8 is an explanatory diagram of a lottery table for symbols to be statically displayed on each valiable display portion according to the exemplary embodiment of the present invention.

FIG. 9 is an explanatory diagram of winning combinations and an award table for each winning combination according to the exemplary embodiment of the present invention.

FIG. 10 is a flowchart of a main process program according to the exemplary embodiment of the present invention.

FIG. 11 is a flowchart of a start reception process program according to the exemplary embodiment of the present invention.

FIG. 12 is a flowchart of a lottery process program according to the exemplary embodiment of the present invention.

FIG. 13 is a flowchart of a game process program according to the exemplary embodiment of the present invention.

FIG. 14 is a flowchart of another game process program according to the exemplary embodiment of the present invention.

FIG. 15 is an explanatory diagram showing three scatters statically displayed on three variable display portions according to the exemplary embodiment of the present invention.

FIG. 16 is an explanatory diagram showing display contents on a lower liquid crystal display in a shell chance game according to the exemplary embodiment of the present invention.

FIG. 17 is an explanatory diagram of a table to be used in the shell chance game according to the exemplary embodiment of the present invention.

FIG. 18 is an explanatory diagram showing contents of shells on the lower liquid crystal display in the shell chance game according to the exemplary embodiment of the present invention.

FIG. 19 is a flowchart of a treasure bonus game process program according to the exemplary embodiment of the present invention.

FIG. 20 is an explanatory diagram showing display contents on the lower liquid crystal display in the treasure bonus game according to the exemplary embodiment of the present invention.

FIG. 21 is an explanatory diagram showing number codes for lower treasure boxes in the treasure bonus game according to the exemplary embodiment of the present invention.

FIG. 22 is an explanatory diagram of a table to be used at a time of determining contents of the lower treasure boxes in the treasur bonus game according to the exemplary embodiment of the present invention.

FIG. 23 is an explanatory diagram of a table to be used at a time of determining whether or not each lower treasure box accommodates an object “clownfish” in the treasure bonus game according to the exemplary embodiment of the present invention.

FIG. 24 is an explanatory diagram showing three contents that three opened lower treasure boxes accommodate in the treasure bonus game according to the exemplary embodiment of the present invention.

FIG. 25 is an explanatory diagram showing an object “clownfish” poping out of one lower treasure box in the treasure bonus game according to the exemplary embodiment of the present invention.

FIG. 26 is an explanatory diagram of display contents on an upper liquid crystal display in the treasure bonus game according to the exemplary embodiment of the present invention.

FIG. 27 is an explanatory diagram showing number codes for upper treasure boxes in the treasure bonus game according to the exemplary embodiment of the present invention.

FIG. 28 is an explanatory diagram of a table to be used at a time of determining a content of a first upper treasure box in the treasure bonus game according to the exemplary embodiment of the present invention.

FIG. 29 is an explanatory diagram of a table to be used at a time of determining a content of a second upper treasure box in the treasure bonus game according to the exemplary embodiment of the present invention.

FIG. 30 is an explanatory diagram of a table to be used at a time of determining a content of a third upper treasure box in the treasure bonus game according to the exemplary embodiment of the present invention.

FIG. 31 is an explanatory diagram of a table to be used at a time of determining one upper treasure box to be opened by an object “clownfish” in the treasure bonus game according to the exemplary embodiment of the present invention.

FIG. 32 is an explanatory diagram showing a content of the second treasure box opened by an object “clownfish” in the treasure bonus game according to the exemplary embodiment of the present invention.

FIG. 33 is an explanatory diagram showing another display contents on the lower liquid crystal display in the treasure bonus game according to the exemplary embodiment of the present invention.

FIG. 34 is a flowchart of an object process program according to the exemplary embodiment of the present invention.

FIG. 35 is an explanatory diagram of a table in which contents of the lower treasure boxes and information for presence or absence of an object “clownfish” are stored in the treasure bonus game according to the exemplary embodiment of the present invention.

FIG. 36 is an explanatory diagram of another table in which contents of the lower treasure boxes and information for presence or absence of an object “clownfish” are stored in the treasure bonus game according to the exemplary embodiment of the present invention.

FIG. 37 is an explanatory diagram showing display contents in which a part of the lower treasure boxes is deleted in the treasure bonus game according to the exemplary embodiment of the present invention.

### DESCRIPTION OF THE PREFERRED EMBODIMENTS

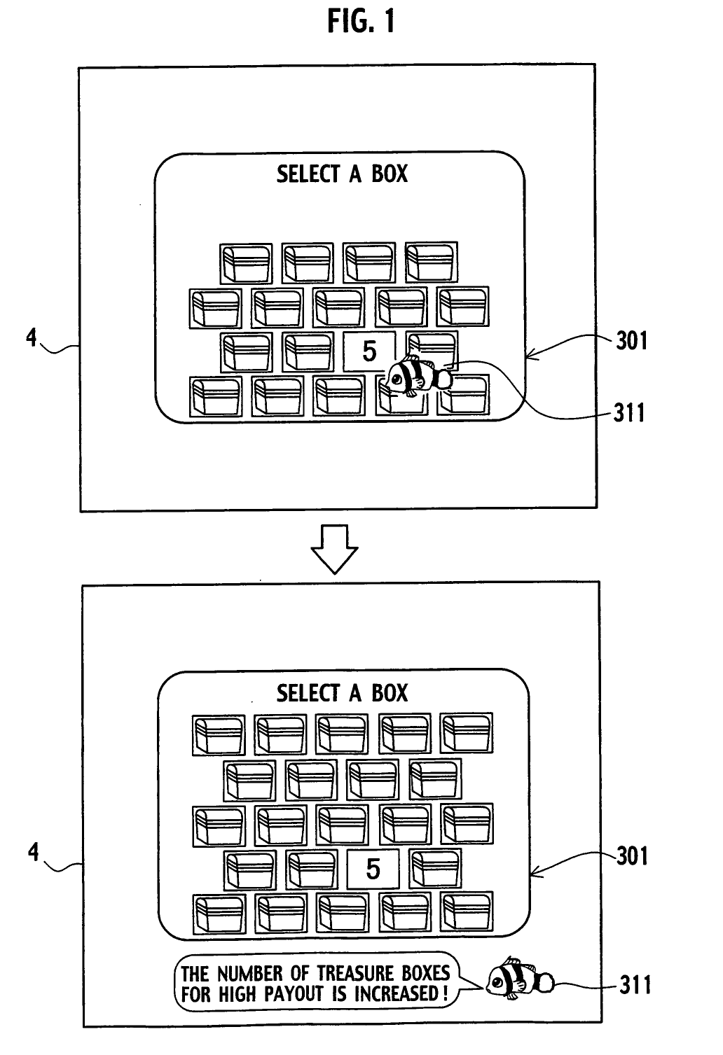

With reference to FIGS. 1 to 37, an exemplary embodiment of the present invention will be described below.

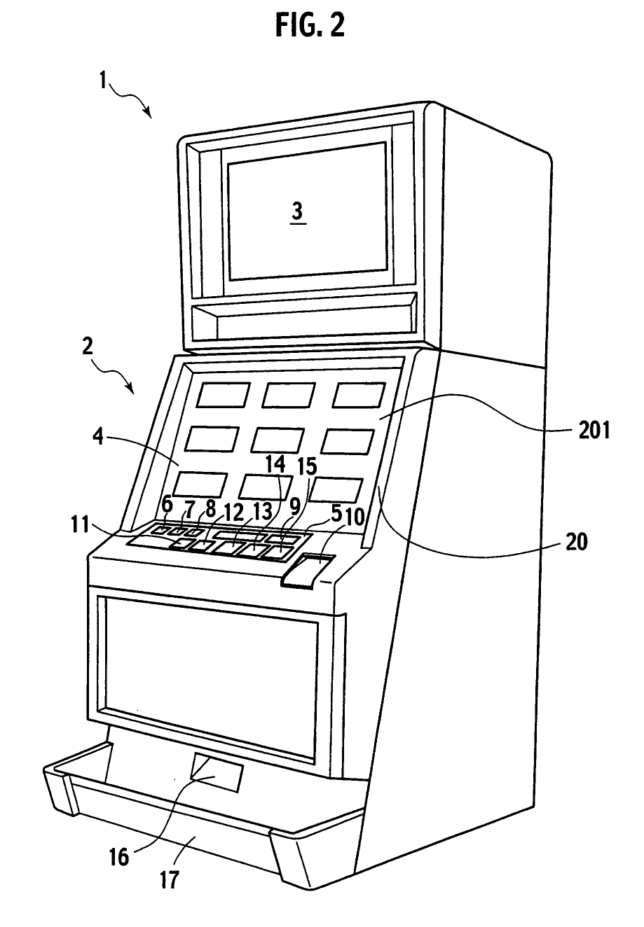

As shown in FIG. 2, a slot machine 1 comprises a cabinet 2, an upper liquid crystal display 3, a lower liquid crystal display 4, an operation table 5, a coin insertion portion 9, a bill insertion portion 10, a coin payout opening 16, a coin receiving portion 17, a front panel 20 and a transparent touch panel 201.

The cabinet 2 forms the entirety of the slot machine 1. The upper liquid crystal display 3 is mounted on a front upper portion of the cabinet 2. The lower liquid crystal display 4 is mounted within the front panel 20 on a front center portion of the cabinet 2. The upper liquid crystal display 3 and the lower liquid crystal display 4 are general liquid crystal displays. The transparent touch panel 201 is mounted on a front face of the lower liquid crystal display 4.

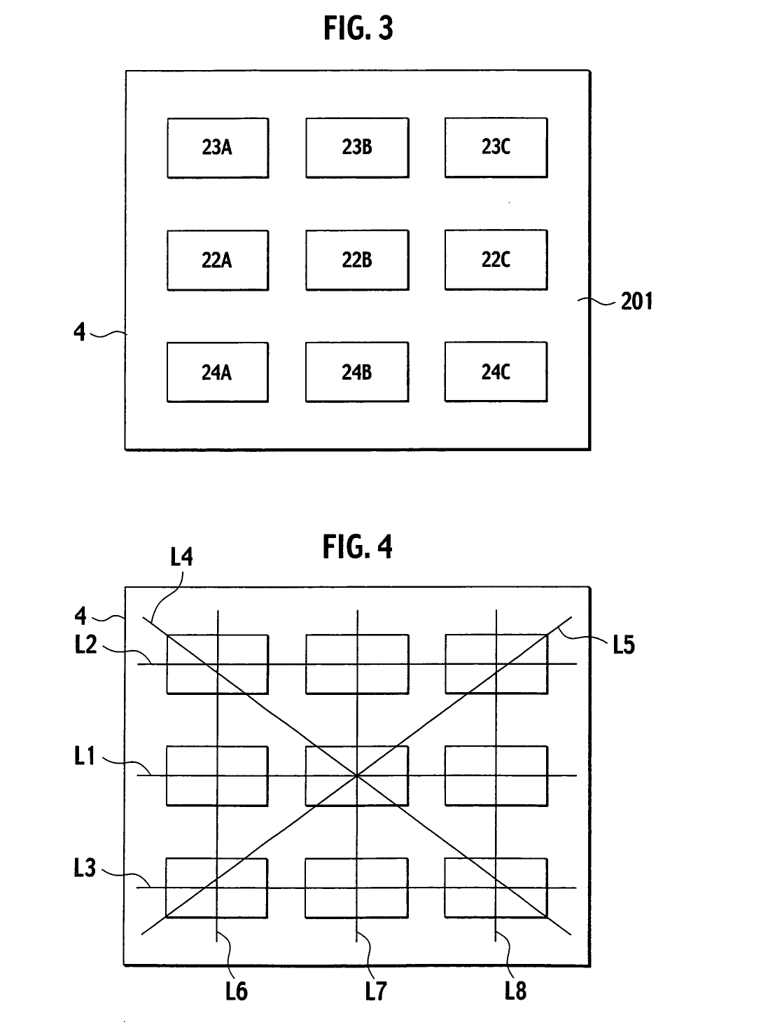

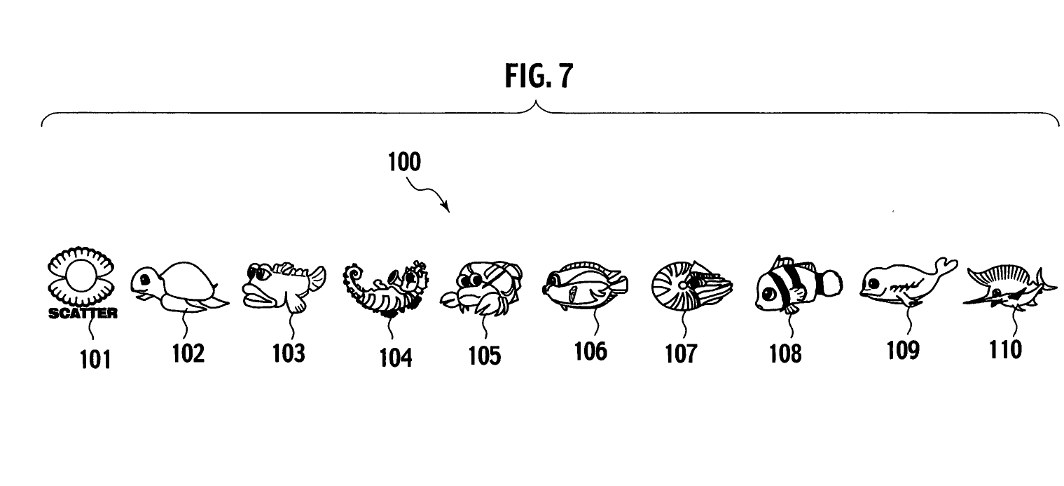

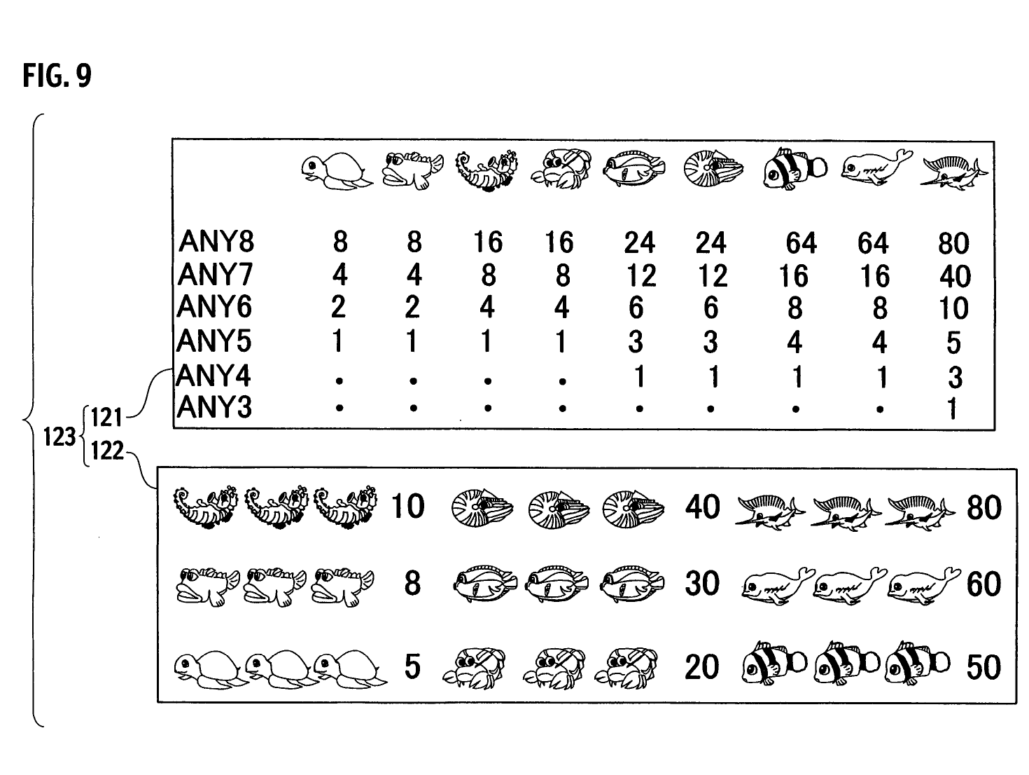

Plural pieces of information regarding a game, such as a game playing method, an award table 123 (see FIG. 9) in which types of winning combinations and awards for the winning combinations are shown, and various effects for the game, are displayed on the upper liquid crystal display 3. Variable display portions 22A to 22C, 23A to 23C, 24A to 24C (see FIG. 3) and activated paylines L1 to L8 (see FIG. 4) are displayed on the lower liquid crystal display 4. Various symbols shown in FIG. 7 are variably displayed on each variable display portion from the right to the left of each variable display portion while a video reel 100 rotates.

The operation table 5 is mounted below the lower liquid crystal display 4 and protrudes forward from the front center portion of the cabinet 2. A change button 6, a cashout button 7, a help button 8, and the coin insertion portion 9 are arranged at the back of the operation table 5 in the order from the left side. A 1-BET button 11, a spin/repeat BET button 12, a 3-BET button 13, a 5-BET button 14, and an 8-BET button 15 are arranged at the front of the operation table 5 in the order from the left side. The bill insertion portion 10 is arranged at the right side of the operation table 5.

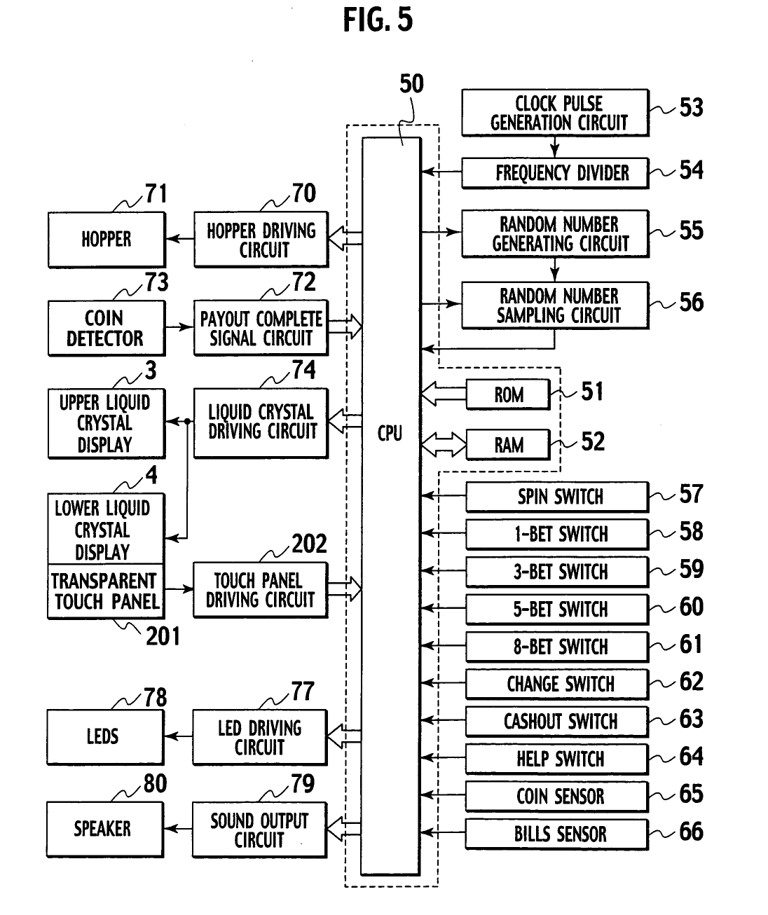

The change button 6 is pushed when a player will change a bill inserted into the bill insertion portion 10. One or more coins into which the inserted bill is changed are paid out into the coin receiving portion 17 via the coin payout opening 16. The change button 6 is provided with a change switch 62. If the change button 6 is pushed, a switch signal is output from the change switch 62 to a CPU 50 (central processing unit) (see FIG. 5).

The cashout button 7 is pushed when the game is finished. If the cashout button 7 is pushed, one or more coins corresponding to one or more game media obtained by a player at the game are paied out into the coin receiving portion 17 via the coin payout opening 16. The cashout button 7 is provided with a cashout switch 63. If the cashout button 7 is pushed, a switch signal is output from the cashout switch 63 to the CPU 50 (see FIG. 5).

The help button 8 is pushed, when a player does not know a playing method of the game etc. If the help button 8 is pushed, various pieces of help information are displayed on the upper liquid crystal display 3. The help button 8 is provided with a help switch 64. If the help button 8 is pushed, a switch signal is output from the help switch 64 to the CPU 50 (see FIG. 5).

The coin insertion portion 9is provided with a coin sensor 65. If one or more coins are inserted into the coin insertion portion 9, a coin detection signal is output from the coin sensor 65 to the CPU 50 (see FIG. 5).

The bill insertion portion 10 is provided with a bill sensor 66. If one or more bills are inserted into the bill insertion portion 10, a bill detection signal is output from the bill sensor 66 to the CPU 50 (see FIG. 5).

The 1-BET button 11 is pushed when a player bets one game medium on the game. One game medium is bet on the game every time the 1-BET button 11 is pushed. The 1-BET button 11 is provided with a 1-BET switch 58. If the 1-BET button 11 is pushed, a switch signal is output from the 1-BET switch 58 to the CPU 50 (see FIG. 5).

The spin/repeat BET button 12 is pushed when a player starts playing the game in a current bet number or previous bet number of game media. If the spin/repeat BET button 12 is pushed, the various symbols are variably displayed on the variable display portions 22A to 22C, 23A to 23C, 24 A to 24C. The spin/repeat BET button 12 is provided with a spin switch 57. If the spin/repeat BET button 12 is pushed, a switch signal is output from the spin switch 57 to the CPU 50 (see FIG. 5). It is noted that the number of game media to be bet on the game is limited to one, two, three, four, five or eight according to the push of the spin/repeat BET button 12.

The 3-BET button 13 is pushed when a player bets three game media on the game. Three game media are bet on the game every time the 3-BET button 13 is pushed. The 3-BET button 13 is provided with a 3-BET switch 59. If the 3-BET button 13 is pushed, a switch signal is output from the 3-BET switch 59 to the CPU 50 (see FIG. 5).

The 5-BET button 14 is pushed when a player bets five game media on the game. Five game media are bet on the game every time the 5-BET button 14 is pushed. The 5-BET button 14 is provided with a 5-BET switch 60. If the 5-BET button 14 is pushed, a switch signal is output from the 5-BET switch 60 to the CPU 50 (see FIG. 5).

The 8-BET button 15 is pushed when a player bets eight game media on the game. Eight game media are bet on the game every time the 8-BET button 15 is pushed. The 8-BET button 15 is provided with an 8-BET switch 61. If the 8-BET button is pushed, a switch signal is output from the 8-BET switch 61 to the CPU 50 (see FIG. 5).

It is noted that the number of game media to be bet on the game is limited to one, two, three, four, five or eight according to the push of the 1-BET button 11, the spin/repeat BET button 12, the 3-BET button 13, the 5-BET button 14, or the 8-BET button 15. When the number of bet game media is one, one payline is activated among the activated paylines L1 to L8. When the number of bet game media is two, two paylines are activated among the activated paylines L1 to L8. When the number of bet game media is three, three paylines are activated among the activated paylines L1 to L8. When the number of bet game media is five, five paylines are activated among the activated paylines L1 to L8. When the number of bet game media is eight, all activated paylines L1 to L8 is activated. The slot machine 1 may have another button which allows all activated paylines L1 to L8 to be activated by one bet game medium. We will describe below the game that proceedes in the condition where all activated paylines L1 to L8 is activated.

The coin payout opening 16 is mounted on a lower portion of the cabinet 2. The coin receiving portion 17 is mounted on the lower portion of the cabinet 2 to receive one or more coins paid out from the coin payout opening 16. A coin detection portion 73 is mounted within the coin payout opening 16 and detects the number of coins paid out from the coin payout opening 16 (see FIG. 5).

Next, the various symbols will be described below. As shown in FIG. 7, the symbols are a scatter 101, a sea turtule 102, a goggle-eyed goby 103, a sea horse 104, a crab 105, a flagtail surgeon fish 106, an ammonite 107, a clownfish 108, a seal 109 and a spearfish 110. These symbols are variably displayed on each variable display portion from the right to the left of each variable display portion while the video reel 100 is rotated.

Next, a control system of the slot machine 1 will be described with reference to FIG. 5.

As shown in FIG. 5, the control system of the slot machine 1 comprises the upper liquid crystal display 3, the lower liquid crystal display 4, the CPU 50, a ROM (read only memory) 51, a RAM (random access memory) 52, a clock pulse generating circuit 53, a frequency divider 54, a random number generating circuit 55, a random number sampling circuit 56,the spin switch 57, the 1-BET switch 58, the 3-BET switch 59, the 5-BET switch 60, the 8-BET switch 61, the change switch 62, the cashout switch 63, the help switch 64, the coin sensor 65, the bill sensor 66, a hopper driving circuit 70, a hopper 71, a payout complete signal circuit 72, the coin detector 73, a liquid crystal driving circuit 74, an LED (light emitting diode) diriving circuit 77, a plurality of LEDs 78, a sound output circuit 79, a speaker 80,the transparent touch panel 201 and a touch panel driving circuit 202.

The ROM 51 and the RAM 52 are connected to the CPU 50. The ROM 51 stores a main process program, a start reception process program, a lottery process program, a game process program, a lottery table to be employed to select symbols to be statically displayed in the game, and various programs and data tables to be employed to execute necessary control processes in the slot machine 1 therein. The RAM 52 temporarily stores various data calculated by the CPU 50 therein.

The clock pulse generating circuit 53, the frequency divider 54, the random number generating circuit 55 and the random number sampling circuit 56 are connected to the CPU 50. The clock pulse generating circuit 53 generates a reference clock pulse. The random number generating circuit 55 generates a random number in series. Random numbers sampled by the random number sampling circuit 56 are employed at various lotteries such as a lottery for a winning combination. The spin switch 57, the 1-BET switch 58, the 3-BET switch 59, the 5-BET switch 60, the 8-BET switch 61, the change switch 62, the cashout switch 63, and the help switch 64 are connected to the CPU 50. The spin switch 57 is mounted to the spin/repeat BET button 12. The 1-BET switch 58 is mounted to the 1-BET button 11. The 3-BET switch 59 is mounted to the 3-BET button 13. The 5-BET switch 60 is mounted to the 5-BET button 14. The 8-BET switch 61 is mounted to the 8-BET button 15. The change switch 62 is mounted to the change button 6. The cashout switch 63 is mounted to the cashout button 7. The help switch 64 is mounted to the help button 8. The CPU 50 controls an operation corresponding to each button on the basis of a switch signal output from each switch by pushing the each button.

The coin sensor 65 and the bill sensor 66 are connected to the CPU 50. The coin sensor 65 detects a coin inserted into the coin insertion portion 9 and outputs a coin detecting signal into the CPU 50. The CPU 50 calculates the number of inserted coins on the basis of the coin detecting signal. The bill sensor 66 detects a type and amount of a bill inserted into the bill insertion portion 10 and outputs a bill detecting signal into the CPU 50. The CPU 50 calculates the number of coins corresponding to the amount of inserted bill on the basis of the bill detecting signal.

The hopper 71 is connected to the CPU 50 via the hopper driving circuit 70. If the CPU 50 outputs a driving signal into the hopper driving circuit 70, the hopper 71 pays out a certain number of coins from the coin payout opening 16. The coin detector 73 is connected to the CPU 50 via the payout complete signal circuit 72. The coin detector 73 is mounted in the coin payout opening 16. If the coin detector 73 detects that the certain number of coins is paid out from the coin payout opening 16, the coin detector 73 outputs a coin payout detecting signal into the payout complete signal circuit 72. The payout complete signal circuit 72 outputs a payout complete signal into the CPU 50 on the basis of the coin payout detecting signal. The upper liquid crystal display 3 and the lower liquid crystal display 4 are connected to the CPU 50 via the liquid crystal driving circuit 74 and controlled by the CPU 50.

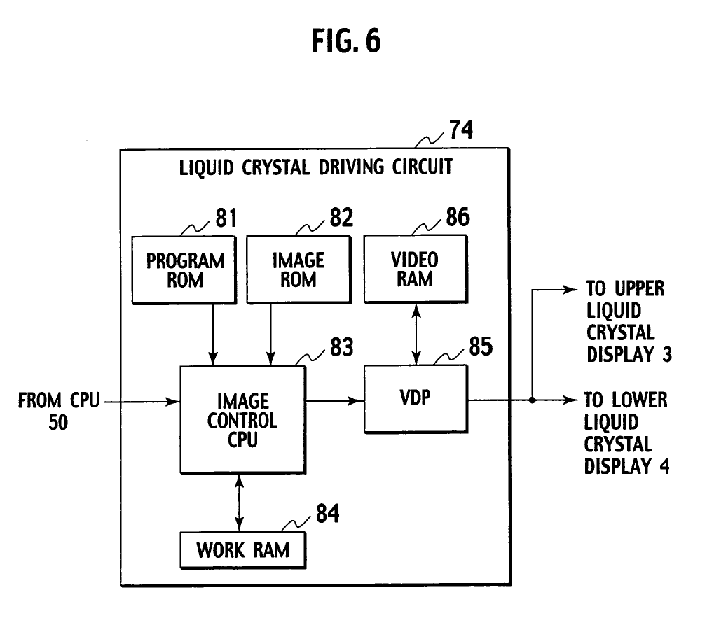

As shown in FIG. 6, the liquid crystal driving circuit 74 comprises a program ROM 81, an image ROM 82, an image control CPU 83, a work RAM 84, a VDP (video display processor) 85, and a video RAM 86. The program ROM 81 stores therein an image control program and various select tables to be employed to display images on the upper liquid crystal display 3 and/or the lower liquid crystal display 4. The image ROM 82 stores therein dot data for forming images such as an effect image for a demonstration and various images for a treasure bonus to be displayed on the upper liquid crystal display 3 and/or the lower liquid crystal display 4, the help information and the award table to be displayed on the upper liquid crystal display 3, and the various symbols of the video reel 100 to be displayed on the lower liquid crystal display 4. The image control CPU 83 selects an image to be displayed on the upper liquid crystal display 3 or the lower liquid crystal display 4 from among the dot data previously stored in the image ROM 82, according to the image control program previously stored in the program ROM 81, on the basis of a parameter determined by the CPU 50. The work RAM 84 tempolarily stores the image control program therein when the image control CPU 83 executes the image control program. The VDP 85 generates image data corresponding to display contents determined by the image control CPU 83 and outputs the generated image data to the upper liquid crystal display 3 and/or the lower liquid crystal display 4. Thereby, as shown in FIG. 7, the various images of the video reel 100 are displayed on the variable display portion 22A to 22C, 23A to 23C, 24A to 24C of the lower liquid crystal display 4. The video RAM 86 tempolarily stores the image data therein when the VDP 85 generates the image data.

Various winning combinations are previously determined in the ROM 51 (see FIG. 9). When a symbol combination identical to one of the winning combinations is statically displayed on each of the activated paylines L1 to L8, one or more coins are paid out from the coin payout opening 16 according to the stopped winning combination.

The transparent touch panel 201 is connected to the CPU 50 via the touch panel driving circuit 202. The transparent touch panel 201 is mounted on a screen of the lower liquid crystal display 4 and outputs to the CPU 50 coordinate position information including a position where a player touches the transparent touch panel 201. Thereby, the CPU 50 identifies the position where the player touches the transparent touch panel 201.

The LEDs 78 are connected to the CPU 50 via the LED driving circuit 77. The LEDs 78 are mounted on a front surface of the slot machine 1 and lighted by the LED driving circuit 77 on the basis of driving signals from the CPU 50 when the various effects are carried out. The speaker 80 is connected to the CPU 50 via the sound out put circuit 79. The speaker 80 generates various effect sounds on the basis of output signals from the sound output circuit 79 when the various effects are carried out.

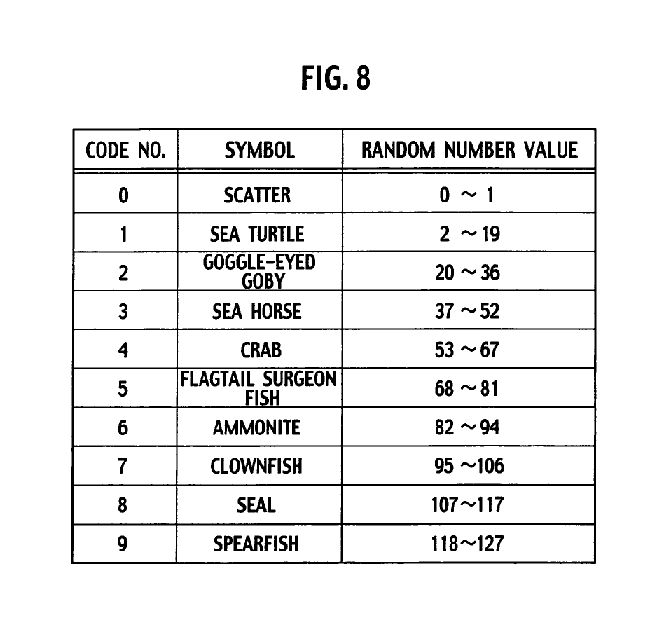

One symbol is statically displayed on each variable display portion on the basis of the lottery table shown in FIG. 8. The lottery table is stored in the ROM 51. Symbols to be statically displayed on the variable display portions 22A to 22C, 23A to 23C, 24A to 24C are determined every the variable display portions 22A to 22C, 23A to 23C, 24A to 24C. In the lottery table, code numbers “0”, “1”, “2”, “3”, “4”, “5”, “6”, “7”, “8” and “9” are respectively assigned to the scatter 101, the sea turtule 102, the goggle-eyed goby 103, the sea horse 104, the crab 105, the flagtail surgeon fish 106, the ammonite 107, the clownfish 108, the seal 109 and the spearfish 110. Also, ranges of random numbers “0 to 1”, “2 to 19”, “20 to 36”, “37 to 52”, “53 to 67”, “68 to 81”, “82 to 94”, “95 to 106”, “107 to 117” and “118 to 127” are respectively assigned to the scatter 101, the sea turtule 102, the goggle-eyed goby 103, the sea horse 104, the crab 105, the flagtail surgeon fish 106, the ammonite 107, the clownfish 108, the seal 109 and the spearfish 110. Nine random numbers corresponding to the variable display portions 22A to 22C, 23A to 23C, 24A to 24C are sampled through the random number sampling circuit 56.

If one random number corresponding to the variable display portion 23A is sampled and belongs within the range of random number “0 to 1”, the scatter 101 to which the code number “0” is assigned is statically displayed on the variable display portion 23A. If one random number corresponding to the variable display portion 23A is sampled and belongs within the range of random number “2 to 19”, the sea turtule to which the code number “1” is assigned is statically displayed on the variable display portion 23A. If one random number corresponding to the variable display portion 23A is sampled and belongs within the range of random number “20 to 36”, the goggle-eyed goby 103 to which the code number “2” is assigned is statically displayed on the variable display portion 23A. If one random number corresponding to the variable display portion 23A is sampled and belongs within the range of random number “37 to 52”, the sea horse 104 to which the code number “3” is assigned is statically displayed on the variable display portion 23A. If one random number corresponding to the variable display portion 23A is sampled and belongs within the range of random number “53 to 67”, the carb 105 to which the code number “4” is assigned is statically displayed on the variable display portion 23A.

If one random number corresponding to the variable display portion 23A is sampled and belongs within the range of random number “68 to 81”, the flagtail surgeon fish 106 to which the code number “5” is assigned is statically displayed on the variable display portion 23A. If one random number corresponding to the variable display portion 23A is sampled and belongs within the range of random number “82 to 94”, the ammonite 107 to which the code number “6” is assigned is statically displayed on the variable display portion 23A. If one random number corresponding to the variable display portion 23A is sampled and belongs within the range of random number “95 to 106”, the clownfish 108 to which the code number “7” is assigned is statically displayed on the variable display portion 23A. If one random number corresponding to the variable display portion 23A is sampled and belongs within the range of random number “107 to 117”, the seal 109 to which the code number “8” is assigned is statically displayed on the variable display portion 23A. If one random number corresponding to the variable display portion 23A is sampled and belongs within the range of random number “118 to 127”, the spearfish 110 to which the code number “9” is assigned is statically displayed on the variable display portion 23A. The same symbol determination process is applied to the other variable display portions 22A to 22C, 23B to 23C, 24A to 24C.

With reference to FIG. 9, the winning combinations and awards for the winning combinations will be described below. The award table 123 includes an award sub-table 121 for ANY odds and an award sub-table 122 for LINE odds and is stored in the ROM 51.

The award sub-table 121 for ANY odds shows an award to be given to a player with respect to each symbol, according to the number of same symbols statically displayed on all or a part of the variable display portions 22A to 22C, 23A to 23C, 24A to 24C which cross one or more activated paylines displayed on the lower liquid crystal display 4. For example, if the random numbers selected on five variable display portions on the activated paylines belong within the range “2 to 19”, “ANY 5 of the sea turtle 102” is won (see FIG. 8). In this case, the sea turtles 102 are statically displayed on the five variable display portions and a player can obtain a payout “1”. As described above, each award for ANY odds is paid out according to the award sub-table 121 for ANY odds shown in FIG. 9.

The award sub-table 122 for LINE odds shows an award per one line to be given to a player with respect to each symbol, according to the number of activated paylines each crossing all variable display portions on which the same symbols are statically displayed. For example, if the random numbers selected on all variable display portions on one activated payline belong within the range “2 to 19”, “sea turtle—sea turtle—sea turtle” is won (see FIG. 8). In this case, the sea turtles 102 are statically displayed on the all variable display portions and a player can obtain a payout “5”. It is noted that when there is a plurality of activated paylines each on which the “sea turtle—sea turtle—sea turtle” is won, a player can obtain a payout generated by multiplying the number of activated paylines by the payout “5”. As described above, each award for LINE odds is paid out according to the award sub-table 122 for LINE odds shown in FIG. 9.

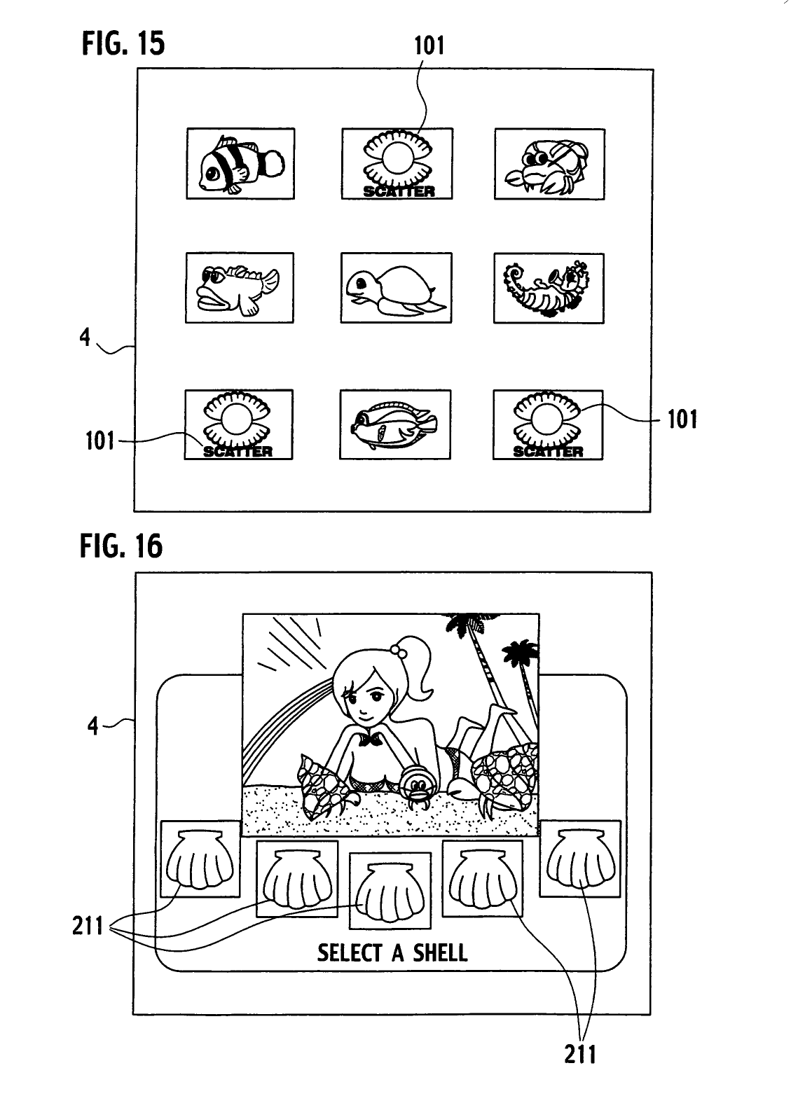

Here, if three or more random numbers corresponding to three or more variable display portions on one or more activated paylines are sampled and belong within the range of random number “0 to 1”, the scatters 101 are statically displayed on the three or more variable display portions (see FIG. 15). Then, a shell chance game is executed on the lower liquid crystal display 4.

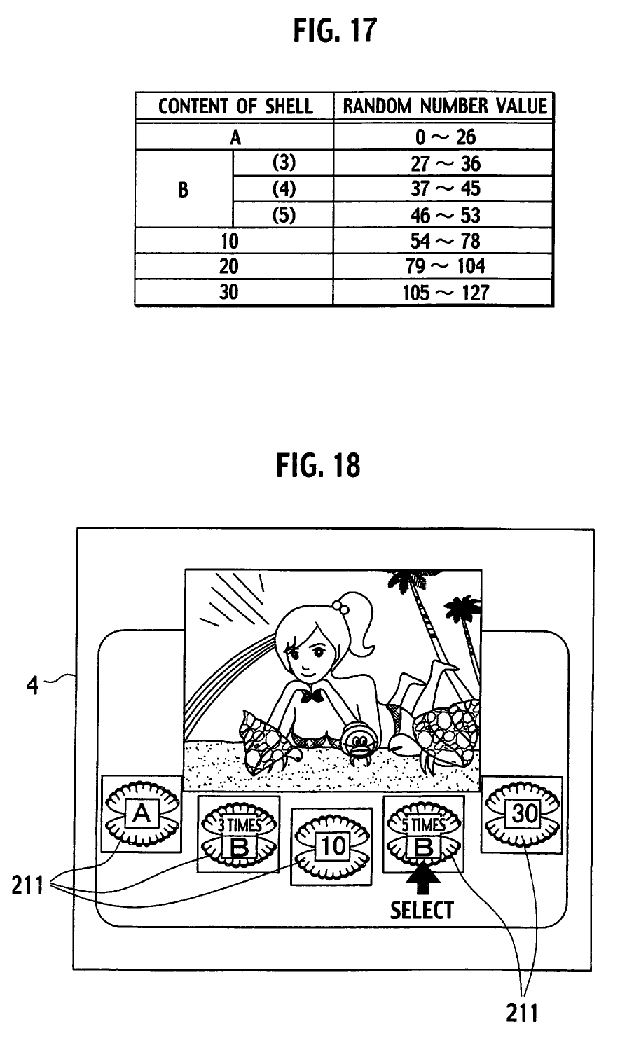

When the slot machine 1 starts to execute the shell chance game, five shells 211 are displayed on the lower liquid crystal display 4 (see FIG. 16). Each shell 211 contains one contant of “A”, “B(3)”, “B(4)”, “B(5)”, “10”, “20” and “30” therein. The one content is selected with reference to one random number sampled within the range of random number “0 to 127” by means of the random number sampling circuit 56 and a table shown in FIG. 17.

If one random number sampled by the random number sampling circuit 56 belongs within the range of random number “0 to 26”, “A” is selected as the one content. If one random number sampled by the random number sampling circuit 56 belongs within the range of random number “27 to 36”, “B(3)” is selected as the one content. If one random number sampled by the random number sampling circuit 56 belongs within the range of random number “37 to 45”, “B(4)” is selected as the one content. If one random number sampled by the random number sampling circuit 56 belongs within the range of random number “46 to 53”, “B(5)” is selected as the one content. If one random number sampled by the random number sampling circuit 56 belongs within the range of random number “54 to 78”, “10” is selected as the one content. If one random number sampled by the random number sampling circuit 56 belongs within the range of random number “79 to 104”, “20” is selected as the one content. If one random number sampled by the random number sampling circuit 56 belongs within the range of random number “105 to 127”, “30” is selected as the one content.

When a player touches one of the five shells 211 displayed on the lower liquid crystal display 4 via the transparent touch panel 201 and selects the one shell 211, as shown in FIG. 18, five contents of the five shells 211 are displayed on the lower liquid crystal display 4. If one content of the shell 211 is “B(3)”, characters “B” and “3 times” are displayed. If one content of the shell 211 is “B (4)”, characters “B” and “4 times” are displayed. If one content of the shell 211 is “B(5)”, characters “B” and “5 times” are displayed. Also, when the player selects the one shell 211, an arrow is displayed on the lower liquid crystal display 4 to indicate the selected one shell 211.

If one content of the selected one shell 211 is “A”, another bonus game is executed. In the exemplary embodiment, contents of the another bonus game are omitted. If one content of the selected one shell 211 is one of “B(3)”, “B(4)” and “B(5)”, the treasure bonus game is executed. Contents of the treasure bonus game will be described later. If one content of the selected one shell 211 is “10”, the player can obtain a payout of “10”. If one content of the selected one shell 211 is “20”, the player can obtain a payout of “20”. If one content of the selected one shell 211 is “30”, the player can obtain a payout of “30”.

Here, as shown in FIG. 16, in the situation where the five shells 211 are displayed on the lower liquid crystal display 4, at least one of the five contents of the five shells 211 maybe one of “A”, “B(3)”, “B(4) ” and “B(5)” such that the player can certainly play the another bonus game or the treasure bonus game.

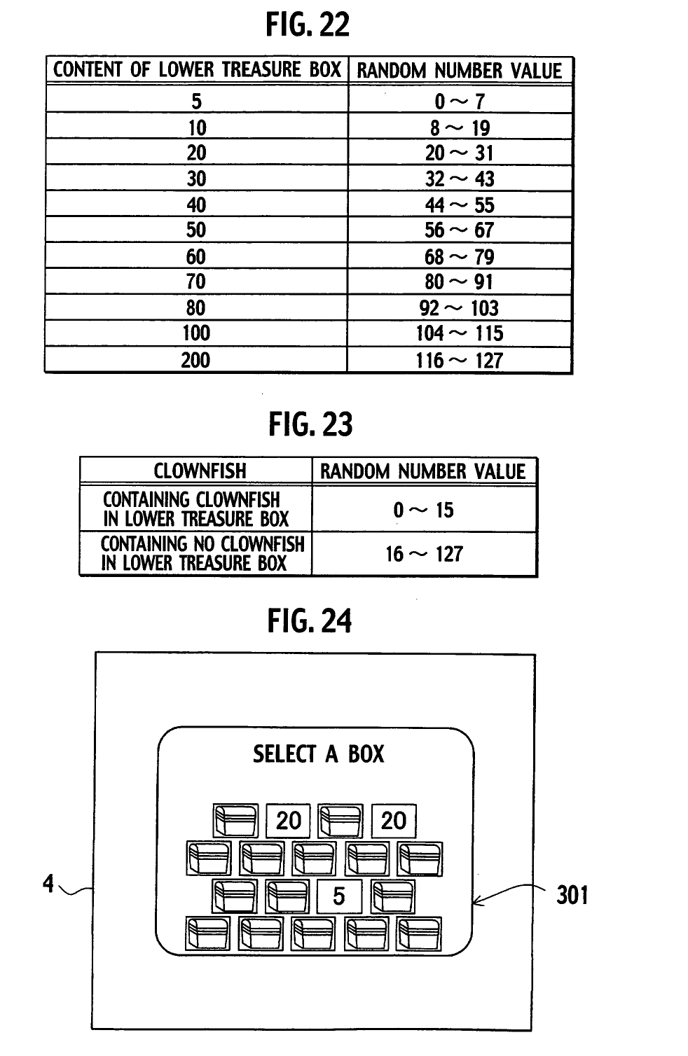

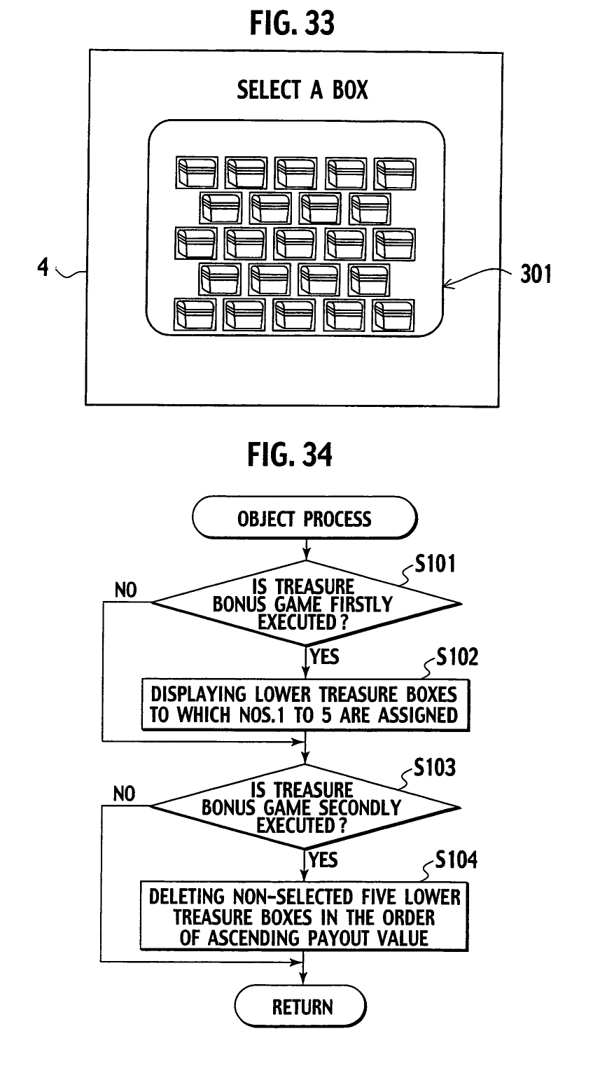

Next, the treasure bonus game will be described below. In the treasure bonus game, the CPU 50 first displays eighteen lower treasure boxes 301 (see FIG. 20) on the lower liquid crystal display 4 among twenty three lower treasure boxes 301 to be displayed on the lower liquid crystal display 4 (see FIG. 33). Therefore, five lower treasure boxes 301 are not displayed on the lower liquid crystal display 4 among the twenty three lower treasure boxes 301. Each of the twenty three lower treasure boxes 301 contains one content of “5”, “10”, “20”, “30”, “40”, “50”, “60”, “70”, “80”, “100” and “200” therein. The one content is selected with reference to one random number sampled within the range of random number “0 to 127” by means of the random number sampling circuit 56 and a table shown in FIG. 22.

If one random number sampled by the random number sampling circuit 56 belongs within the range of random number “0 to 7”, “5” is selected as the one content. If one random number sampled by the random number sampling circuit 56 belongs within the range of random number “8 to 19”, “10” is selected as the one content. If one random number sampled by the random number sampling circuit 56 belongs within the range of random number “20 to 31”, “20” is selected as the one content. If one random number sampled by the random number sampling circuit 56 belongs within the range of random number “32 to 43”, “30” is selected as the one content. If one random number sampled by the random number sampling circuit 56 belongs within the range of random number “44 to 55”, “40” is selected as the one content. If one random number sampled by the random number sampling circuit 56 belongs within the range of random number “56 to 67”, “50” is selected as the one content. If one random number sampled by the random number sampling circuit 56 belongs within the range of random number “68 to 79”, “60” is selected as the one content. If one random number sampled by the random number sampling circuit 56 belongs within the range of random number “80 to 91”, “70” is selected as the one content. If one random number sampled by the random number sampling circuit 56 belongs within the range of random number “92 to 103”, “80” is selected as the one content. If one random number sampled by the random number sampling circuit 56 belongs within the range of random number “104 to 115”, “100” is selected as the one content. If one random number sampled by the random number sampling circuit 56 belongs within the range of random number “116 to 127”, “200” is selected as the one content.

Further, each of the twenty three lower treasure boxes 301 is either one box containing an object “clownfish” therein or another box not containing an object “clownfish” therein. The one or another box is selected with reference to one random number sampled within the range of random number “0 to 127” by means of the random number sampling circuit 56 and a table shown in FIG. 23.

If one random number sampled by the random number sampling circuit 56 belongs within the range of random number “0 to 15”, the one box is selected as the lower treasure box. If one random number sampled by the random number sampling circuit 56 belongs within the range of random number “16 to 127”, the another box is selected as the lower treasure box.

After the CPU 50 has determined the contents of the twenty three lower treasure boxes 301, the CPU 50 exchanges all or a part of the contents of the non-displayed five lower treasure boxes 301 for the contents of the displayed eighteen lower treasure boxes 301 so that the numerical values of the contents of the non-displayed five lower treasure boxes 301 are larger than those of the contents of the displayed eighteen lower treasure boxes 301. Here, the CPU 50 exchanges the one box (or the another box) for the another box (or the one box) when one non-displayed lower treasure box 301 contains (or does not contain) an object “clownfish” therein and one displayed lower treasure box 301 to be exchanged for the one non-displayed lower treasure box 301 does not contain (or contains) an object “clownfish” therein.

As shown in FIG. 26, three upper treasure boxes 401 are displayed on the upper liquid crystal display 3. Hereinafter, we describe the three upper treasure boxes 401 as a first upper treasure box 401, a second upper treasure box 401 and a third upper treasure box 401 in this order from the left to the right of the upper liquid crystal display 3 in a case of identifying each of the three upper treasure box 401.

The first upper treasure box 401 contains one contain of “number of times+1 time”, “number of times+2 times” and “number of times+3 times” therein. The one content is selected with reference to one random number sampled within the range of random number “0 to 127” by means of the random number sampling circuit 56 and a table shown in FIG. 28.

If one random number sampled by the random number sampling circuit 56 belongs within the range of random number “0 to 67”, “number of times+1 time” is selected as the one content. If one random number sampled by the random number sampling circuit 56 belongs within the range of random number “68 to 115”, “number of times+2 times” is selected as the one content. If one random number sampled by the random number sampling circuit 56 belongs within the range of random number “116 to 127”, “number of times+3 times” is selected as the one content.

The second upper treasure box 401 contains one contain of “payout*2”, “payout*3”, “payout*5” and “payout*10” therein. The one content is selected with reference to one random number sampled within the range of random number “0 to 127” by means of the random number sampling circuit 56 and a table shown in FIG. 29.

If one random number sampled by the random number sampling circuit 56 belongs within the range of random number “0 to 55”, “payout*2” is selected as the one content. If one random number sampled by the random number sampling circuit 56 belongs within the range of random number “56 to 91”, “payout*3” is selected as the one content. If one random number sampled by the random number sampling circuit 56 belongs within the range of random number “92 to 115”, “payout*5” is selected as the one content. If one random number sampled by the random number sampling circuit 56 belongs within the range of random number “116 to 127”, “payout*10” is selected as the one content.

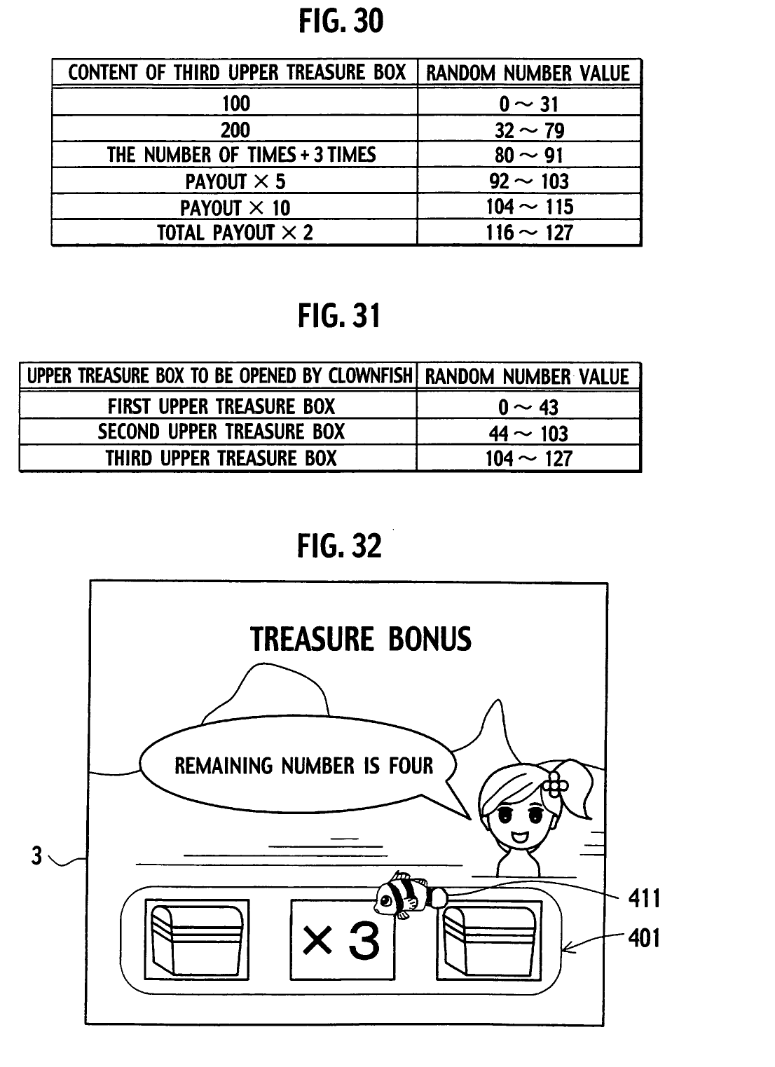

The third upper treasure box 401 contains one contain of “100”, “200”, “number of times+3 times”, “payout*5”, “payout*10” and “total payout*2” therein. The one content is selected with reference to one random number sampled within the range of random number “0 to 127” by means of the random number sampling circuit 56 and a table shown in FIG. 30.

If one random number sampled by the random number sampling circuit 56 belongs within the range of random number “0 to 31”, “100” is selected as the one content. If one random number sampled by the random number sampling circuit 56 belongs within the range of random number “32 to 79”, “200” is selected as the one content. If one random number sampled by the random number sampling circuit 56 belongs within the range of random number “80 to 91”, “number of times+3 times” is selected as the one content. If one random number sampled by the random number sampling circuit 56 belongs within the range of random number “92 to 103”, “payout*5” is selected as the one content. If one random number sampled by the random number sampling circuit 56 belongs within the range of random number “104 to 115”, “payout*10” is selected as the one content. If one random number sampled by the random number sampling circuit 56 belongs within the range of random number “116 to 127”, “total payout*2” is selected as the one content.

A player can select a certain number of lower treasure boxes 301 among the eighteen lower treasure boxes 301 displayed on the lower liquid crystal display 4 through the transparent touch panel 201, without betting any coins. More specifically, when the shell 211 selected by the player in the shell chance game contains “B(3)” therein, the certain number of lower treasure boxes 301 is three. When the shell 211 selected by the player in the shell chance game contains “B(4)” therein, the certain number of lower treasure boxes 301 is four. When the shell 211 selected by the player in the shell chance game contains “B(5)” therein, the certain number of lower treasure boxes 301 is five. The player selects one lower treasure box 301 and then the CPU 50 opens the selected one lower treasure box 301 to display the content of the selected one lower treasure box 301. Further, the player selects one lower treasure box 301 and then the CPU 50 displays remaining number of the certain number of lower treasure boxes 301 on the upper liquid crystal display 3 (see FIG. 26). As shown in FIG. 24, contents (“20”, “20”, “5”) of three opened lower treasure boxes 301 selected by the player are displayed on the lower liquid crystal display 4. In this case, each opened lower treasure box 301 does not contain an object “clownfish” therein.

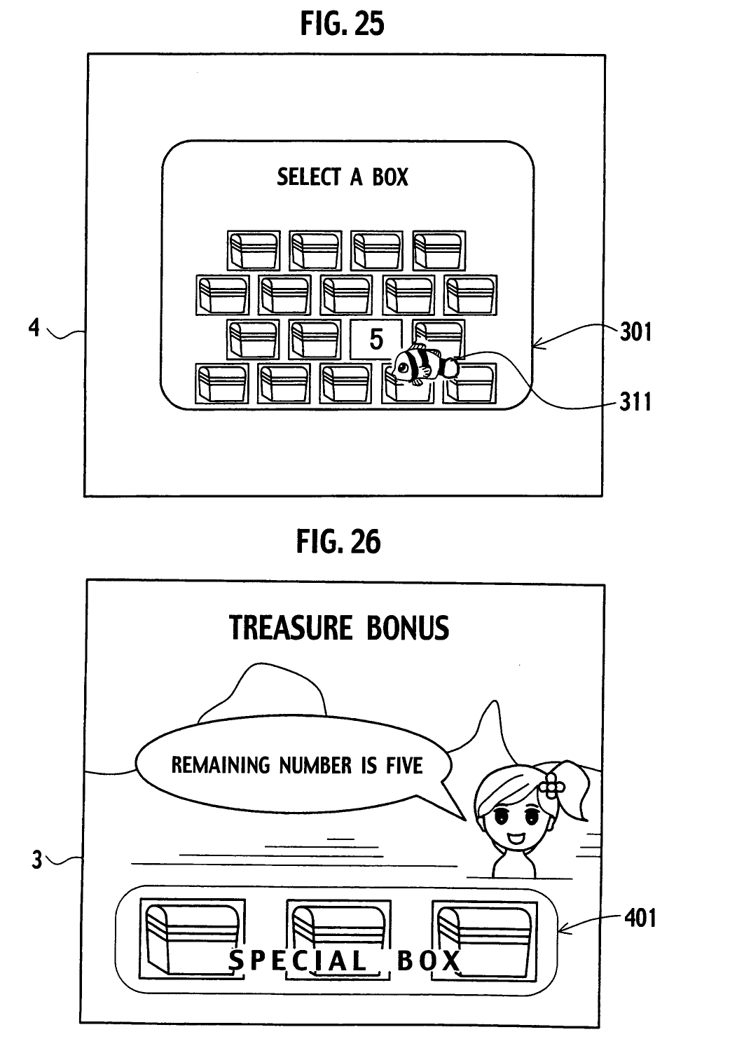

On the other hand, when an opened lower treasure box 301 contains an object “clownfish” therein, a content (“5”) of the opened lower treasure box 301 selected by the player is displayed on the lower liquid crystal display 4 and an object “clownfish” 311 is simultaneously displayed on the the lower liquid crystal display 4 such that it pops out of the opened lower treasure box 301 as shown in FIG. 25. For example, as shown in FIG. 32, the object “clownfish” 311 moves to the upper liquid crystal display 3 and then is displayed as an object “clownfish” 411. The object “clownfish” 411 moves to one closed upper treasure box 401. When the object “clownfish” 411 arrives at the one upper treasure box 401, the one upper treasure box 401 is opened and a content (*3) of the one upper treasure box 401 is displayed on the upper liquid crystal display 3.

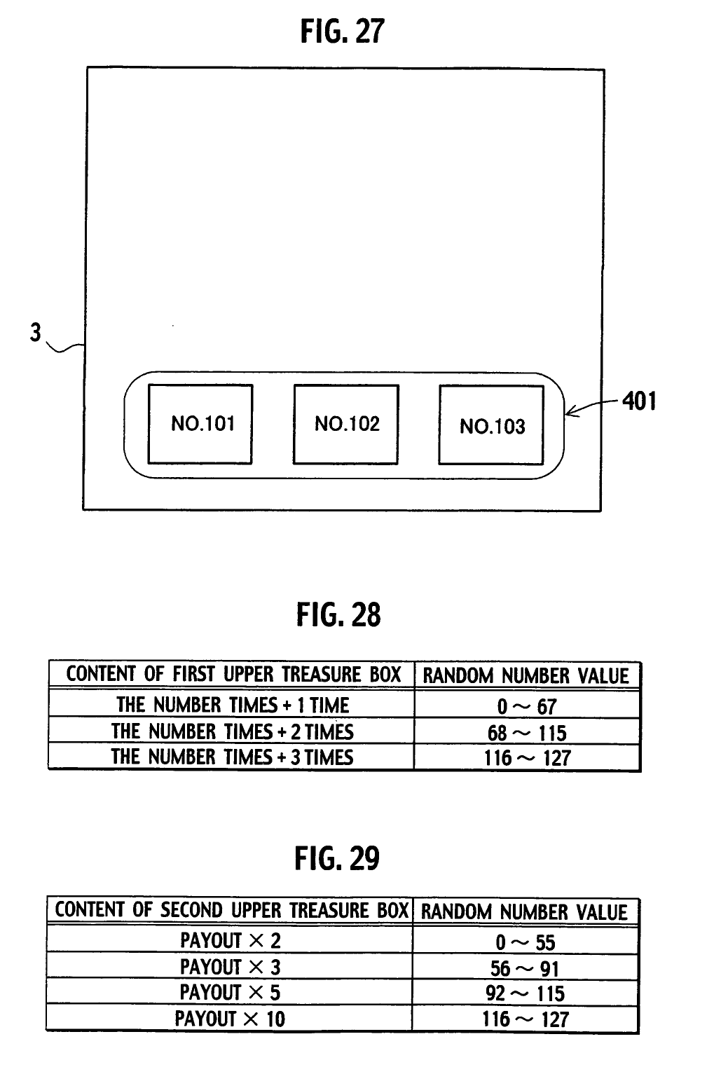

One upper treasure box 401 to be opened is selected with reference to one random number sampled within the range of random number “0 to 127” by means of the random number sampling circuit 56 and a table shown in FIG. 31. Three upper treasure boxes 401 displayed on the upper liquid crystal display 3 are previously assigned with No.101, No.102 and No.103, respectively (see FIG. 27)

If one random number sampled by the random number sampling circuit 56 belongs within the range of random number “0 to 43”, the first upper treasure box 401 as singed with No. 101 is selected as the one upper treasure box 401 to be opened. If one random number sampled by the random number sampling circuit 56 belongs within the range of random number “44 to 103”, the second upper treasure box 401 assinged with No. 102 is selected as the one upper treasure box 401 to be opened. If one random number sampled by the random number sampling circuit 56 belongs within the range of random number “104 to 127”, the third upper treasure box 401 assinged with No. 103 is selected as the one upper treasure box 401 to be opened.

If one selected upper treasure box 401 is already opened on the upper liquid crystal display 3, the above-described lottery process is repeated until one closed upper treasure box 401 is selected. On the other hand, if the three upper treasure boxes 401 are opened, the above-described lottery process is not executed.

The player can obtain a content of one upper treasure box 401 opened by the object “clownfish” 411 displayed on the upper liquid crystal display 3. More specifically, when the content of the one opened upper treasure box 401 is “number of times+1 time”, the number of times for which the player selects the lower treasure box 301 is increased by 1 time. When the content of the one opened upper treasure box 401 is “number of times+2 times”, the number of times for which the player selects the lower treasure box 301 is increased by 2 times. When the content of the one opened upper treasure box 401 is “number of times+3 times”, the number of times for which the player selects the lower treasure box 301 is increased by 3 times. When the content of the one opened upper treasure box 401 is “payout*2”, the amount of payout in one selected lower treasure box 301 is doubled. When the content of the one opened upper treasure box 401 is “payout*3”, the amount of payout in one selected lower treasure box 301 is tripled. When the content of the one opened upper treasure box 401 is “payout*5”, the amount of payout in one selected lower treasure box 301 is quintupled. When the content of the one opened upper treasure box 401 is “payout*10”, the amount of payout in one selected lower treasure box 301 is decupled. When the content of the one opened upper treasure box 401 is “100”, the player obtains a payout of “100”. When the content of the one opened upper treasure box 401 is “200”, the player obtains a payout of “200”. When the content of the one opened upper treasure box 401 is “total payout*2”, the amount of payouts in all selected lower treasure boxes 301 is doubled.

In this manner, when a player finish selecting one or more lower treasure boxes 301 according to the number of times determined by the content of the shell 211 selected in the shell chance game and/or the content of the upper treasure box 401 opened by the object “clownfish” 411 in the treasure bonus game, the player can obtain the amount of payouts resulting from summing up one or more contents of the one or more selected lower treasure boxes 301 and a content of the opened upper treasure box 401.

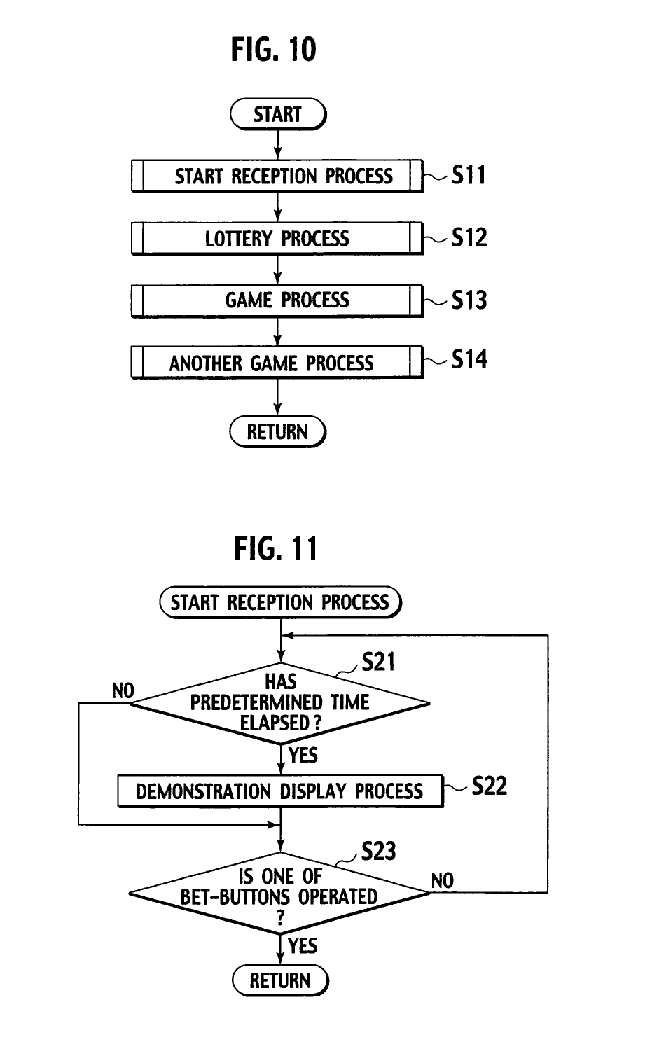

Next, a main process program will be described below, with reference to FIG. 10. In step S11, the CPU 50 carries out a start reception process. In the start reception process, one switch signal output from the spin switch 57, the 1-BET switch 58, the 3-BET switch 59, the 5-BET switch 60, or the 8-BET switch 61 according to an operation of the spin/repeat BET button 12, the 1-BET button 11, the 3-BET button 13, the 5-BET button 14, or the 8-BET button 15 is received. It is noted that the game is started when the CPU 50 receives the one switch signal.

In step S12, the CPU 50 carries out a lottery process according to the one switch signal output from the spin switch 57, the 1-BET switch 58, the 3-BET switch 59, the 5-BET switch 60, or the 8-BET switch 61. In step S13, the CPU 50 carries out a game process. In step S14, the CPU 50 carries out an another game process. The main process program is terminated after the another game process is carried out.

Next, the start reception process will be described in detail below, with reference to FIG. 11. In step S21, the CPU 50 determines whether or not a predetermined time (e.g. 15 seconds) has elapsed. If the predetermined time has not elapsed, the process proceeds to step S23. If the predetermined time has elapsed, the process proceeds to step S22. In step S22, the CPU 50 displays the effect image for the demonstration on the upper liquid crystal display 3 and/or the lower liquid crystal display 4. In step S23, the CPU 50 determines whether or not the operation of the spin/repeat BET button 12, the 1-BET button 11, the 3-BET button 13, the 5-BET button 14, or the 8-BET button 15 is carried out. If the operation is not carried out, the process returns to step S21. If the operation is carried out, the CPU 50 interrupts the display of the effect image, and then displays a certain number of activated paylines L1 to L8 on the lower liquid crystal display 4 and the award table 123 on the upper liquid crystal display 3. Then, the process proceeds to step S12.

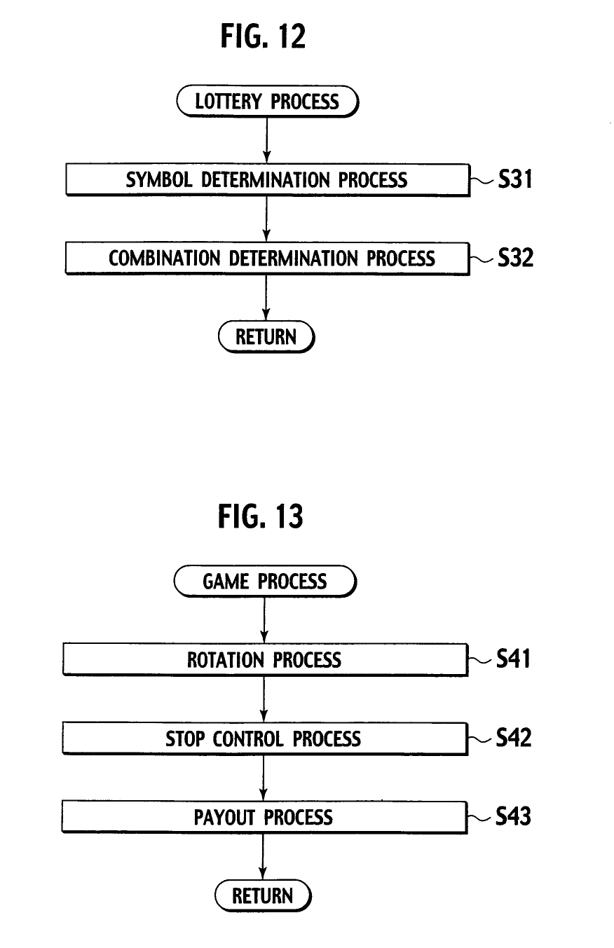

Next, the lottery process will be described in detail below, with reference to FIG. 12. In step S31, the CPU 50 carries out a symbol determination process. In the symbol determination process, the symbols to be statically displayed on the variable display portions 22A to 22C, 23A to 23C, 24A to 24C are determined every the variable display portions 22A to 22C, 23A to 23C, 24A to 24C. More specifically, nine random number values corresponding to the variable display portions 22A to 22C, 23A to 23C, 24A to 24C are sampled within the ranges “0 to 127” through the random number sampling circuit 56, and the symbols to be statically displayed on the variable display portions 22A to 22C, 23A to 23C, 24A to 24C are determined though the code numbers on the basis of the lottery table shown in FIG. 8.

In step S32, the CPU 50 carries out a combination determination process. In the combination determination process, the CPU 50 determines the type of winning combination on each activated payline displayed on the lower liquid crystal display 4 and the award for the winning combination, on the basis of the award table 123 stored in the ROM 51. Then, the process proceeds to step S13.

Next, the game process will be described in detail below, with reference to FIG. 13. In step S41, the CPU 50 carries out a rotation process. In the rotation process, the various symbols shown in FIG. 7 are variably displayed on each variable display portion from the right to the left of each variable display portion, according to the one switch signal output from the spin switch 57, the 1-BET switch 58, the 3-BET switch 59, the 5-BET switch 60, or the 8-BET switch 61, while the video reel 100 rotates.

In step S42, the CPU 50 carries out a stop control process. In the stop control process, one symbol is statically displayed on each variable display portion on the basis of the lottery result in the symbol determination process (step S31).

In step S43, the CPU 50 carries out a payout process. In the payout process, the CPU 50 pays out one or more game media corresponding to an award previously determined in the award table 123 according to the symbols on each activated payline. If a plurality of winning combinations is established on a plurality of activated paylines, the CPU 50 adds up the payouts for the plurality of winning combinations. Therefore, in a case where a plurality of any odds and a plurality of line odds are simultaneously extablished, the CPU 50 pays out game media corresponding to the total amount obtained by adding up the payouts for the any odds and line adds, after multiplying a value of payout change information to any odds and/or line odds to be changed according the payout change information displayed on the upper liquid crystal display 3. Then, the process proceeds to step S14.

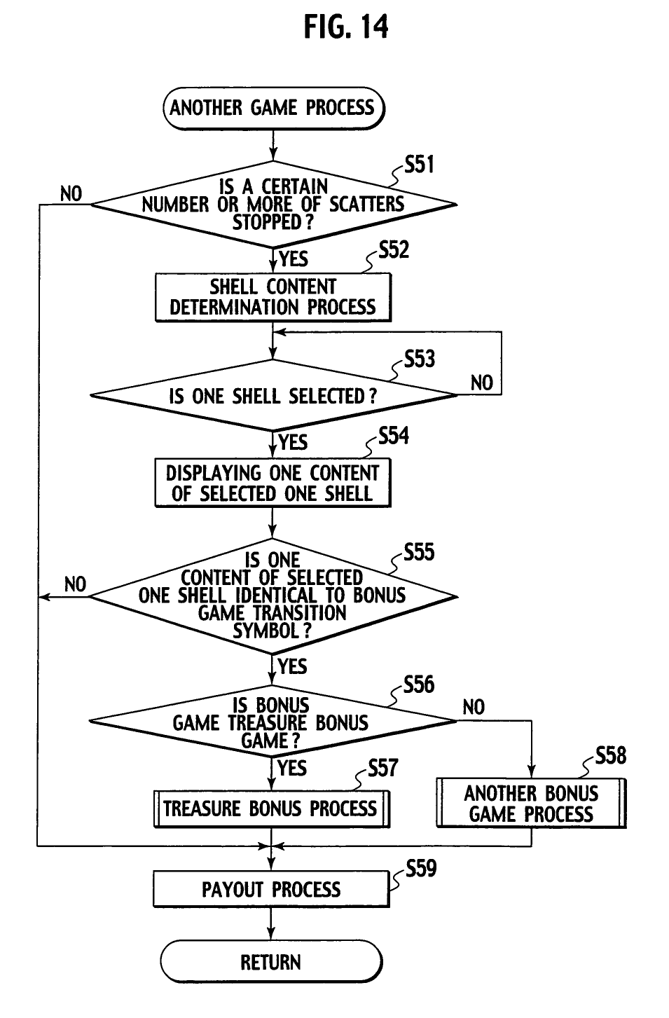

Next, the another game process will be described in detail below, with reference to FIG. 14. In step S51, the CPU 50 determines whether or not a certain number or more of scatters 100 is stopped on the activated paylines L1 to L8 displayed on the lower liquid crystal display 4 (see FIG. 15). In the exemplary embodiment, the certain number is equal to three. If the certain number or more of scatters 100 is not stopped, the process proceeds to step S59. If the certain number or more of scatters 100 is stopped, the process proceeds to step S52.

In step S52, a shell content determination process is carried out. More specifically, the CPU 50 displays five shells 211 on the lower liquid crystal display 4 (see FIG. 16) and then selects one content of each of the five shells 211 among from the contents “A”, “B(3)”, “B(4)”, “B(5)”, “10”, “20”, “30” by using a random number sampled within the range of random number “0 to 127” by means of the table shown in FIG. 17 and the random number sampling circuit 56.

In step S53, the CPU 50 determines whether or not a player selects one shell 211 among from the five shells 211. The player can select the one shell 211 by touching the one shell 211 via the transparent touch panel 201. If the player does not select the one shell 211, the process remains in step S53. If the player selects the one shell 211, the process proceeds to step S54. In step S54, the CPU 50 displays one content of the one shell 211 selected by the player on the lower liquid crystal display 4. In the exemplary embodiment, the CPU 50 displays all contents of the five shells 211 and the arrow for indicating the selected one shell 211.

In step S55, the CPU 50 determines whether or not the one content of the selected one shell 211 is identical to one of bonus game transition symbols. In the exemplary embodiment, the contents “A”, “B(3)”, “B(4)”, “B(5)” are the bonus game transition symbols. If the one content is not identical to one of the bonus game transition symbols, the process proceeds to step S59. If the one content is identical to one of the bonus game transition symbols, the process proceeds to step S56.

In step S56, the CPU 50 determines whether or not the bonus game is the treasure bonus game. In the exemplary embodiment, if the one content is the content “A”, the bonus game is not the treasure bonus game. If the one content is one of the contents “B(3)”, “B(4)”, “B(5)”, the bonus game is the treasure bonus game. If the bonus game is not the treasure bonus game, the process proceeds to step S58. If the bonus game is the treasure bonus game, the process proceeds to step S57. In step S58, another bonus game process is carried out. In the exemplary embodiment, a description of the another bonus game process is omitted.

In step S59, a payout process is carried out. More specifically, if the one content of the selected one shell 211 is one of the contents “10”, “20”, “30” (that is, the bonus game is not the treasure bonus game instep S55), the slot machine 1 pays out one or more game media corresponding to the payout which is equal to a value of each content. Also, the slot machine 1 pays out one or more game media corresponding to the payout which a player obtains in the another bonus game (step S58) or the treasure bonus game (step S57). Then, the process finishes the current main process program and then proceeds to step S10 in a next main process program.

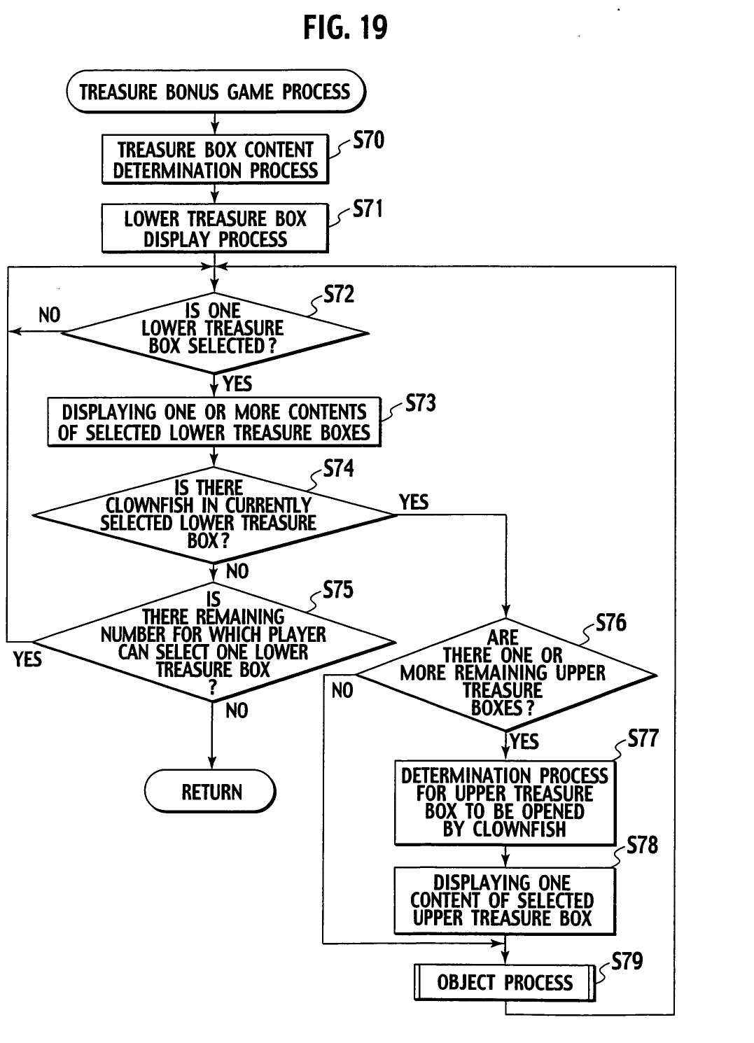

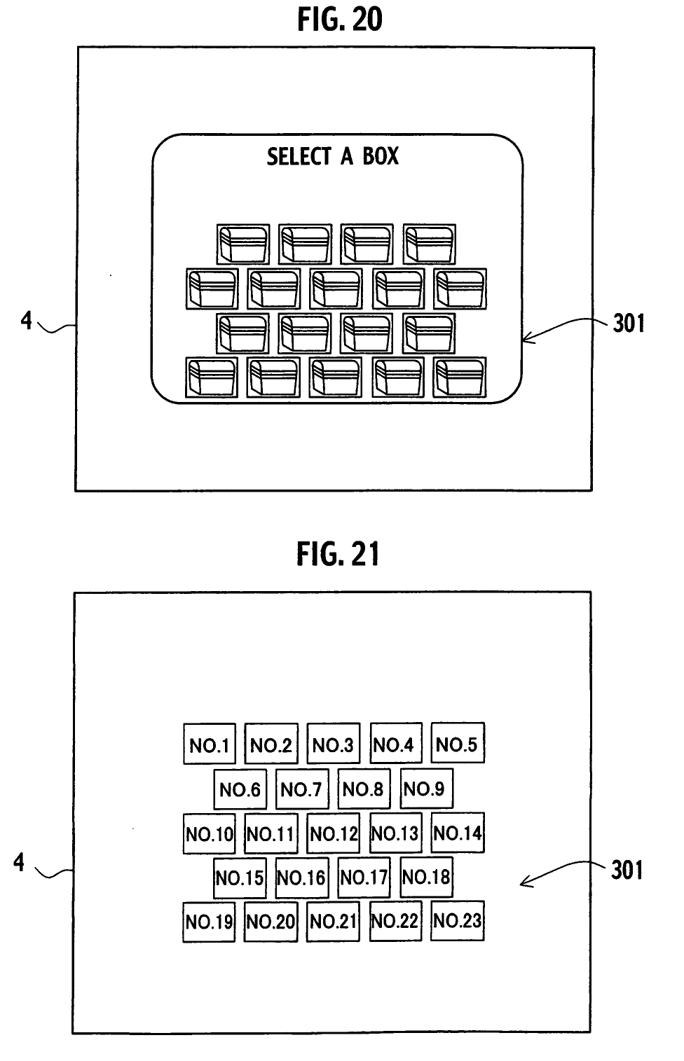

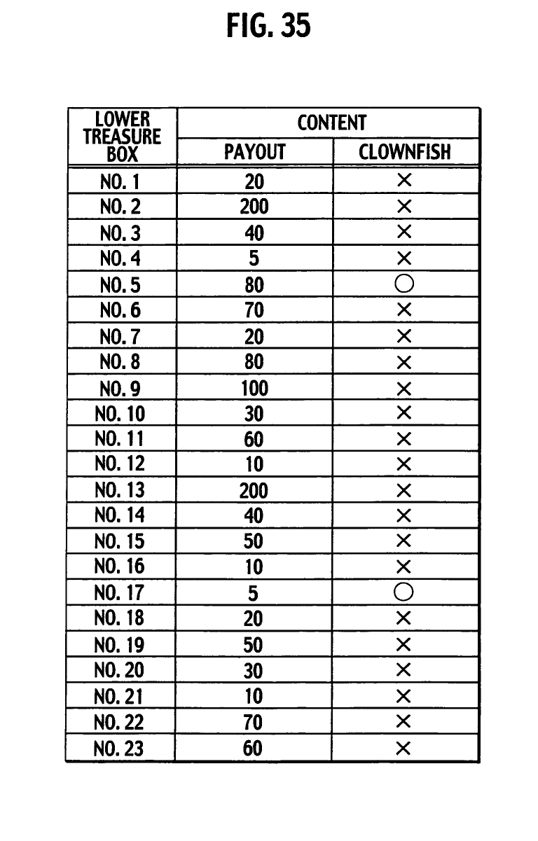

Next, the treasure bonus game process will be described in detail below, with reference to FIG. 19. In step S70, a treasure box content determination process is carried out. More specifically, for example, the CPU 50 previsously assignes the code numbers 1 to 23 to the twenty-three lower treasure boxes 301 to be displayed on the lower liquid crystal display 4 (see FIG. 21). Then, the CPU 50 selects one content of each lower treasure box 301 among the contents “5”, “10”, “20”, “30”, “40”, “50”, “60”, “70”, “80”, “100”, “200” by using a random number sampled within the range of random number “0 to 127” by means of the table shown in FIG. 22 and the random number sampling circuit 56. In addition, the CPU 50 determines whether or not an object “clownfish” is included in each lower treasure box 301. The CPU 50 temporarily stores the selected one content of each lower treasure box 301 and the determination whether or not an object “clownfish” is included in each lower treasure box 301 in a table secured within the RAM 52 (see FIG. 35). In FIG. 35, the code numbers are shown in a column of “lower treasure box” and the payout and the determination are shown in a column of “content”. Regarding the determination, if an object “clownfish” is included in, ◯ is assigned, whereas if an object “clownfish” is not included in, X is assigned.

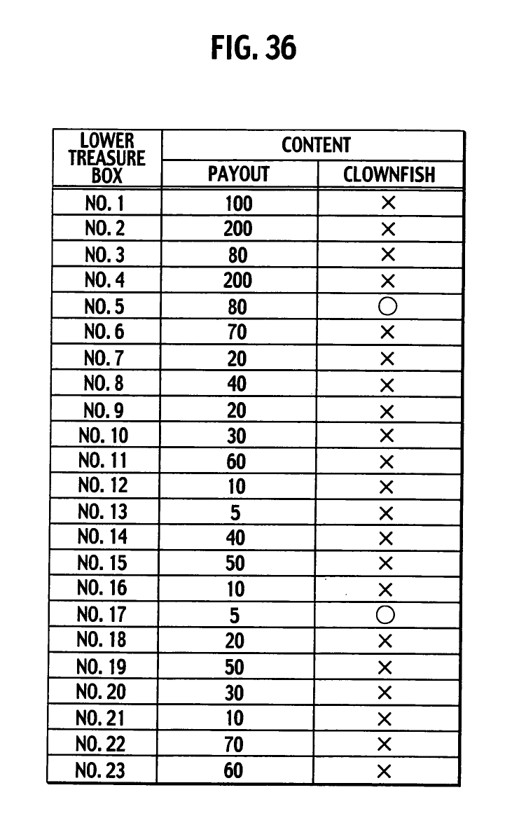

Then, the CPU 50 exchanges all or a part of the contents of the non-displayed five lower treasure boxes (Nos. 1 to 5) 301 for the contents of the displayed eighteen lower treasure boxes (Nos. 6 to 23) 301 so that the numerical values of the contents of the non-displayed five lower treasure boxes 301 are larger than those of the contents of the displayed eighteen lower treasure boxes 301. For example, in a case where the content exchange is carried out under the contents of FIG. 35, the contents “20” and “100” are exchanged between two lower treasure boxes to which Nos. 1 and 9 are assigned, the contents “40” and “80” are exchanged between two lower treasure boxes to which Nos. 3 and 8 are assigned, and the contents “5” and “200” are exchanged between two lower treasure boxes to which Nos. 4 and 13 are assigned. By the content exchange, the CPU 50 changes the contents of FIG. 35 into the contents of FIG. 36 and overwrites the contents of FIG. 35 in the RAM 52.

In addition, the CPU 50 displays three upper treasure boxes 401 on the upper liquid crystal display 3. Then, the CPU 50 selects one content of the first upper treasure box 401 from among the contents “number of times+1 time”, “number of times +2 times”, “number of times+3 times”, one content of the second upper treasure box 401 from among the contents “payout*2”, “payout*3”, “payout*5”, “payout*100”, and one content of the third upper treasure box 401 from among the contents “100”, “200”, “number of times+3 times”, “payout*5”, “payout*10”, “total payout*2”, by using random numbers sampled within the range of random number “0 to 127” by means of the tables shown in FIGS. 28 to 30 and the random number sampling circuit 56. The CPU 50 stores the selected one content of each upper treasure box 401 in a table secured within the RAM 52.

In addition, as shown in FIG. 26, the CPU 50 displays on the upper liquid crystal display 3 remaining number of selecting number for which a player can select one lower treasure box 301. More specifically, in the shell chance game, if one content of shell 211 selected by a player is “B (3)”, “remaining number is three” is displayed. If one content of shell 211 selected by a player is “B (4)”, “remaining number is four” is displayed. If one content of shell 211 selected by a player is “B(5)”, “remaining number is five” is displayed. The CPU 50 stores the remaining number of selecting number in the RAM 52.

In step S71, a lower treasure box display process is carried out. More specifically, as shown in FIG. 20, the CPU 50 displays eighteen lower treasure boxes (Nos.6 to 23) 301 on the lower liquid crystal display 4. At this time, five lower treasure boxes (Nos.1 to 5) are not displayed on the lower liquid crystal display 4. It is noted the lower treasure box display process may be carried out in step S70.

In step S72, the CPU 50 determines whether or not a player selects one lower treasure box 301. If the player does not select the one lower treasure box 301, the process remains in step S72. If the player selects the one lower treasure box 301, the process proceeds to step S73. The player can select one lower treasure box 301 by touching one of the lower treasure boxes 301 displayed on the lower liquid crystal display 4 through the transparent touch panel 201.

Here, it is noted that the player can not select the lower treasure box 301 already opened on the lower liquid crystal display 4. The CPU 50 checks whether or not each lower treasure box 301 is already opened through each flag, which is secured in the RAM 52, corresponding to the each lower treasure box 301. It is further noted that the player can not select the lower treasure box 301 that is not displayed on the lower liquid crystal display 4. The CPU 50 checks whether or not each lower treasure box 301 is displayed on the lower liquid crystal display 4 throught each flag, which is secured in the RAM 52, corresponding to the each lower treasure box 301.

If the player selects the one lower treasure box 301, the CPU 50 subtracts “1” from the remaining number of selection number and then stores the subtracted remaining number in the RAM 52. Then, the CPU 50 updates the remaining number on the upper liquid crystal display 3 and the process preceeds to step S73.

In step S73, the CPU 50 displays one or more contents (any one or more of the contents “5”, “10”, “20”, “30”, “40”, “50”, “60”, “70”, “80”, “100”, “200”) of the lower treasure boxes 301 selected by a player on the lower liquid crystal display 4 (see FIGS. 24, 25). The CPU 50 carries out this display on the basis of the table, which is secured in the RAM 52, in which the content of each lower treasure box 301 is stored (see FIG. 36). One or more flags corresponding to the selected one or more lower treasure boxes 301 represent the opened one or more lower treasure boxes 301.

In step S74, the CPU 50 determines whether or not there is an object “clownfish” in the currently selected lower treasure box 301. The CPU 50 carries out this determination on the basis of the table, which is secured in the RAM 52, in which the information whether or not each lower treasure box 301 contains an object “clownfish” is stored (see FIG. 36). If there is not the object “clownfish”, the process proceeds to step S75. If there is the object “clownfish”, the process proceeds to step S76.

In step S76, the CPU 50 determines whether or not there are one or more closed upper treasure boxes 401 on the upper liquid crystal display 3. The CPU 50 carries out this determination by checking a flag, which is secured in the RAM 52, corresponding to each upper treasure box 401. If there are not one or more closed upper treasure boxes 401, the process proceeds to step S79. If there are one or more closed upper treasure boxes 401, the process proceeds to step S77.

In step S77, a determination process for an upper treasure box 401 to be opened by an object “clownfish” 411 displayed on the upper liquid crystal display 3 is carried out. More specifically, the CPU 50 determines the upper treasure box 401 to be opened by the object “clownfish” 411 by using a random number sampled within the range of random number “0 to 127” by means of the tables shown in FIGS. 31 and the random number sampling circuit 56.

In step S78, the CPU 50 moves an object “clownfish” 311 having poped out of the lower treasure box 301 opened in step S73 to the upper liquid crystal display 3 as an object “clownfish” 411, and moves the object “clownfish” 411 to the upper treasure box 401 selectd in step S77. Then, the CPU 50 displays the content (any one of the contents “number of times+1 time”, “number of times+2 times”, “number of times+3 times”, “payout * 2”, “payout*3”, “payout*5”, “payout*10”, “100”, “200”, “total payout*2”) of the upper treasure box 401 selected in step S77 (see FIG. 32). This content display is carried out on the basis of a table, which is secured in the RAM 52, in which the content of each upper treasure box 401 is stored. A flag corresponding to the upper treasure box 301 selected in step S77 represents the opened upper treasure box 301.

In a case where the content of the opened upper treasure box 401 is any one of the contents “number of times+1 time”, “number of times+2 times”, “number of times+3 times”, the CPU 50 adds the remaining number, for which a player can select one or more closed lower treasure boxes 301, to any one of values “1”, “2”, “3” and then stores the added remaining number in the RAM 52. The CPU 50 updates the remaining number displayed on the upper liquid crystal display 3 on the basis of the added remaining number.

In step S79, an object process is carried out. Then, the process returns to step S72.

On the other hand, if there is not the object “clownfish” in step S74, the process proceeds to step S75. In step S75, the CPU 50 determines whether or not there is the remaining number for which a player can select one lower treasure box 301. In the exemplary embodiment, if any upper treasure box 401 is not opened the remaining number is three times, four times or five times. If the first and/or third upper treasure box 401 is opened, the remaining number is increased by any one of one time, two times, three times, four times, five times and six times. If there is the remaining number, the process returns to step S72. If there is not the remaining number, the process proceeds to step S59 shown in FIG. 14. In step S59, the CPU 50 accumulates a payout corresponding to the content of the selected lower treasure box 301 or upper treasure box 401 and gives the payout to a player. It is here noted that the CPU 50 may give the payout to the player every time when the content of the lower treasure box 301 or the upper treasure box 401 is displayed on the lower liquid crystal display 4 or the upper liquid crystal display 3.

Next, the object process will be described in detail below, with reference to FIG. 34. In step S101, the CPU 50 determines whether or not the treasure bonus game is firstly executed. The CPU 50 adds “1” to the number of times for execution of the treasure bonus game every time when the object process is carried out. When the treasure bonus game is finished, the CPU 50 resets the number of times for execution of the treasure bonus game to “0”. If the treasure bonus game is not firstly executed, the process proceeds to step S103. If the treasure bonus game is firstly executed, the process proceeds to step S102.

In step S102, the CPU 50 displays the five lower treasure boxes (Nos. 1 to 5) 301 on the lower liquid crystal display 4 and a comment “the number of treasure boxes for high payout is increased” as a speech balloon of an object “clownfish” 311 (see FIG. 1). The displayed five lower treasure boxes 301 becomes a selection object for a player. The numerical values of the contents of the five lower treasure boxes 301 are larger than those of the contents of the eighteen lower treasure boxes (Nos. 6 to 23) 301. This increases chances for the player to obtain a high payout. It is here noted that the five lower treasure boxes 301 may be color-displayed on the lower liquid crystal display 4.

In step S103, the CPU 50 determines whether or not the treasure bonus game is secondly executed. If the treasure bonus game is not secondly executed, the process proceeds to step S72 shown in FIG. 19. If the treasure bonus game is secondly executed, the process proceeds to step S104.

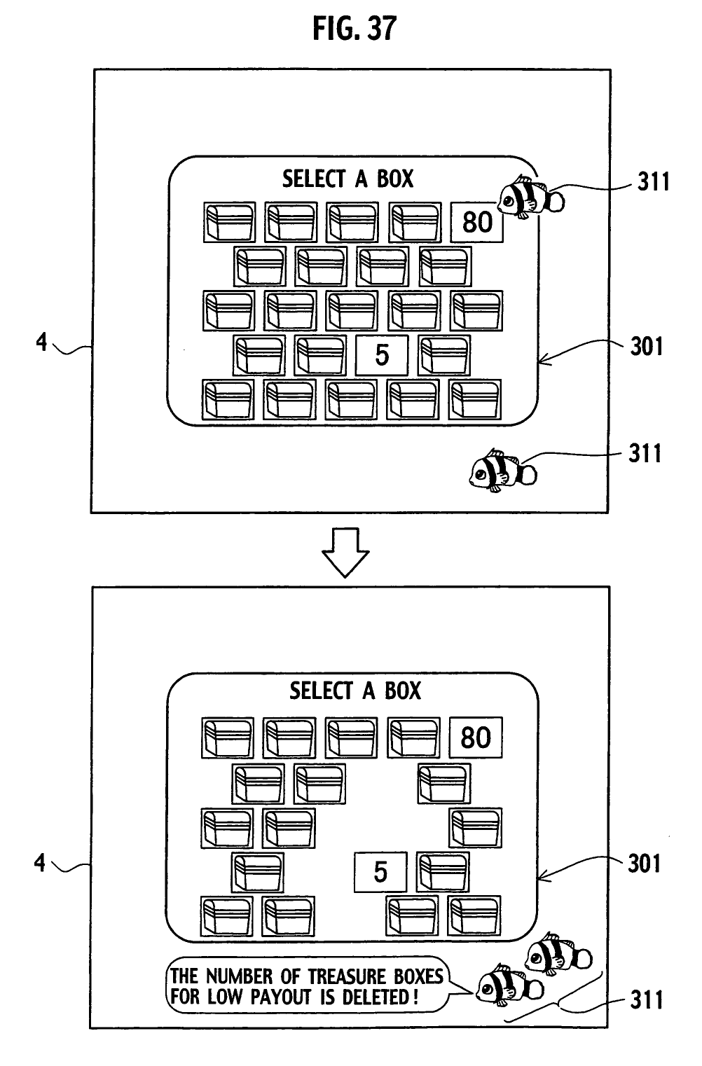

In step S104, the CPU 50 deletes non-opened five lower treasure boxes 301 in the order of ascending a payout value from the lower liquid crystal display 4 and a comment “the number of treasure boxes for low payout is deleted” as a speech balloon of an object “clownfish” 311 (see FIG. 37). In the exemplary embodiment, the five lower treasure boxes 301 to which Nos. 8, 12, 13, 16, 21 are assigned are deleted (see FIG. 36). This also increases chances for the player to obtain a high payout. It is noted that the number of lower treasure boxes 301 to be deleted is not limited to five.

The CPU 50 can know each non-opened lower treasure box 301 through the flag, which is secured in the RAM 52, corresponding to each lower treasure box 301. Also, the CPU 50 can know the content of each lower treasure box 301 through the table, which is secured in the RAM 52, shown in FIG. 36. It is noted that the flag corresponding each lower treasure box 301 also represents information whether or not the corresponding lower treasure box 301 is deleted from the lower liquid crystal display 4.

Next, the advantageous features of the slot machine 1 will be described below.

When a player can obtain a payout in the treasure bonus game according to the content of the lower treasure box 301 selected by the player (see step S59 in FIG. 14), the slot machine 1 decreases the number of the non-opened lower treasure boxes 301 for low payout from the lower liquid crystal display 3 (see step S104 in FIG. 34 and FIG. 37) and increases the number of the non-opened lower treasure boxes 301 for high payout on the lower liquid crystal display 3 (see step S102 in FIG. 34 and FIG. 1), in a case where the selected lower treasure box 301 contains an object “clownfish” 301 therein (see YES of step S74 FIG. 19 and FIG. 25). This brings a fresh sense to the player in the treasure bonus game because the slot machine 1 provides wide selection variations on the lower treasure boxes 301 to keep the player's motivation for a slot game high.

In addition, in the case where the selected lower treasure box 301 contains the object “clownfish” 301 therein, the slot machine 1 provides an award or incentive to the player (see step S59 in FIG. 14 and step S75 in FIG. 19) according to the content of the lower treasure box 301 selected by the player and the content of the upper treasure box 401 opened by an object “clownfish” 411 (step S77 in FIG. 19). This also brings a fresh sense to the player in the treasure bonus game because it is difficult for the player to predict the award or incentive which he/she can obtain.

Next, the modified embodiment of the slot machine 1 will be described below.

In steps S70, S71 in FIG. 19, the CPU 50 may delete a certain number of the lower treasure boxes 301 from the lower liquid crystal display 4 in the order of ascending a payout value, according to the contents of the table in FIG. 35.

In steps S70, S71 in FIG. 19, the CPU 50 may delete a certain number of the lower treasure boxes 301 from the lower liquid crystal display 4 according to the result of a random lottery.

After the above deleting process is executed in steps S70, S71, the CPU 50 may again display the deleted lower treasure boxes 301 on the lower liquid crystal display 4 in step S102 in FIG. 34.

In step S104 in FIG. 34, the CPU 50 may delete one or more non-opened lower treasure boxes 301 displayed on one or more certain regions of the lower liquid crystal display 4.

Step S102 may be exchanged for step S104 in FIG. 34.

The CPU 50 may display the upper treasure boxes 401 on the lower liquid crystal display 4.

The contents of the lower treasure boxes 301 may be one incentive (e.g. the number of times+1 time, the number of times+2 times, the number of times+3 times) for increasing the selection number of the lower treasure boxes 301 or another incentive (e.g. payout*2, payout*3, payout*5, payout*10, total payout*2) for increasing the payout value as well as those of the upper treasure boxes 401. In this case, these incentives correspond to award information of an award giving means.

In step S77, the CPU 50 may determine the upper treasure box 401 to be opened by a player's touching operation via a touch panel, instead of by lottery.

The award may include a multiplying factor, a bonus game and the like, in addition to the payout.

What is claimed is:

1. A gaming machine comprising:
a display that displays a plurality of options including at least one predetermined option;
an input device that accepts input selecting at least one of the plurality of options by a player; and
a processor in communication with the display and the input device,
the processor operable to:
display the plurality of options on the display;
select an option based on the input from the input device;
determine wehther or not an option selected through the input device is the predetermined option; and
change the number of non-selected options displayed on the display if the selected option is the predetermined option.

2. The gaming machine according to claim 1, wherein the processor displays at least one additional option being associated with an award equal to or larger than a first award which is associated with any one of the plurality of options so that the number of non-selected options is increased.

3. The gaming machine according to claim 1, wherein the processor non-displays at least one option being associated with an award equal to or smaller than a second award among the plurality of options so that the number of non-selected options is decreased.

4. The gaming machine according to claim 1, wherein the processor displays an object and award information associated with the selected option on the display, if the selected option is the predetermined option.

5. The gaming machine according to claim 1, further comprising a special display that displays a plurality of special options,
wherein the processor displays the plurality of special options on the special display, selects an special option if the selected option on the display is the predetermined option, and provides an award corresponding to the selected option on the display and the selected special option on the special display.

6. The gaming machine according to claim 5, wherein the processor selects the special option by lottery on the basis of a table in which random values are associated with identification information assigned to the plurality of special options.

7. The gaming machine according to claim 5, wherein the processor displays on the special display the selected special option and an object identical to the object displayed on the display, if the selected option is the predetermined option.

8. The gaming machine according to claim 1, further comprising a memory that stores identification information assigned to each of the plurality of options.

9. A gaming machine comprising:
a display that displays a plurality of options including at least one predetermined option;
an input device that accepts input selecting at least one of the plurality of options by a player; and
a processor in communication with the display and the input device,
the processor operable to:
display the plurality of options on the display;
select an option based on the input from the input device;
determine wehther or not an option selected through the input device is the predetermined option;
change the number of non-selected options displayed on the display if the selected option is the predetermined option; and
display at least one additional option being associated with an award equal to or larger than a first award which is associated with any one the plurality of options so that the number of non-selected options is increased.

10. A gaming machine comprising:
a display that displays a plurality of options including at least one predetermined option;
an input device that accepts input selecting at least one of the plurality of options by a player; and
a processor in communication with the display and the input device,
the processor operable to:
display the plurality of options on the display;
select an option based on the input from the input device;
determine wehther or not an option selected through the input device is the predetermined option;
change the number of non-selected options displayed on the display if the selected option is the predetermined option; and
non-display at least one option being associated with an award equal to or smaller than a second award among the plurality of options so that the number of non-selected options is decreased.
